(19) United States
(12) Patent Application Publication
(10) Pub. No.: US 2006/0053374 A1
(43) Pub. Date: Mar. 9, 2006

(54) Localization of activity with respect to digital data

(75) Inventor: Gregg D. Wilensky, San Francisco, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Adobe Systems Incorporated

(21) Appl. No.: 10/984,465

(22) Filed: Nov. 9, 2004

Related U.S. Application Data
(63) Continuation of application No. PCT/US04/29149, filed on Sep. 7, 2004.

(51) Int. Cl. H04N 5/44

(52) U.S. Cl. 715/716

(57) ABSTRACT

A system to perform localized activity with respect to digital data includes an interface component and an activity component. The interface component is configured to receive a marker location with respect to source digital data. The activity component is configured automatically to perform a parametrically-controlled activity with respect to the source digital data, based on an activity parameter. The activity component is further configured automatically to perform a parametrically-controlled selection of a selected portion of the source digital data, based on the marker location and a portion selection parameter, and to localize an effect of the parametrically-controlled activity to the selected portion of the source digital data.

### RELATED APPLICATION

The present application is a continuation under 35 U.S.C. 111(a) of International Application No. PCT/US2004/029149 filed Sep. 7, 2004, which is incorporated herein by reference.

### FIELD OF TECHNOLOGY

The present application relates generally to the technical fields of computer graphics processing, operator interface processing, and selective visual display systems and, in one exemplary embodiment, to a method and a system to perform localized activity with respect to digital data.

### BACKGROUND

The performance of activities (e.g., adjustments, modifications, editing, etc.) related to digital data is facilitated by many existing editing tools. Take, for example, the process of modifying a digital image by a user utilizing an image editing application. The user typically makes global image adjustments (e.g., the overall lighting and color balance of the global image is modified), whereafter the user may modify local regions of the digital image. After a global adjustment has been made, one object (or feature) of the image may be too dark and need to be lightened. A face of a person appearing in the digital image may be too saturated, or the user may desire to change the color hue of a flower, for example, from red to pink or purple. To make such local adjustments typically requires a two-step process. First, the user makes a selection of the relevant object, utilizing or more selection tools, and then applies an image adjustment to a selected region of the digital image. In the event that the resultant image is not what the user desires, the user is required to undo the effect and redo the selection. It will be appreciated that this may be a somewhat slow and tedious process. Further, the region selection process (e.g., painting the selected region) can be time consuming and inaccurate.

One example of an image editing application is the ADOBE® PHOTOSHOP® image editing application, developed by Adobe System, Inc. of San Jose, Calif. The ADOBE® PHOTOSHOP® application provides a feature called the Color Replacement Brush, which allows a user to create and save constant “brushes” with precise settings, including size, shape, tilt, spacing, scatter, jitter, etc. However, once an image region has been brushed, an image modification is fixed, and parameters that went into creating the modification cannot be changed without undoing and redoing the brush stroke. The ADOBE ® PHOTOSHOP® application further provides a Replace Color Adjustment feature. This feature is, however, limited to a global color range selection.

The ADOBE® PHOTOSHOP® application further provides so-called “Adjustment Layers,” which enable localized adjustment of an image. However, the Adjustment Layers require a user manually to create a selection mask, and the updating of this mask is a multi-step process.

Another image editing application is the MASK PRO 3 application, developed by Extensis, Inc. of Portland, Oreg. This application provides a set of “drop and keep” colors with foreground and background highlighters to produce selection masks.

### SUMMARY OF THE INVENTION

A system performs localized activity with respect to digital data. An interface component receives a marker location with respect to source digital data. An activity component automatically performs a parametrically-controlled activity with respect to the source digital data, based on an activity parameter. The activity component is to perform a parametrically-controlled selection of a selected portion of the source digital data, based on the marker location and a portion selection parameter, and to localize an effect of the parametrically-controlled activity to the selected portion of the source digital data.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a flow diagram, illustrating the performance of an activity, in an exemplary form of an adjustment, to source data in a localized manner to generate destination data, according to two exemplary embodiments.

FIG. 2 is a block diagram illustrating the architecture of a digital data activity application, and associated application data, according to an exemplary embodiment of the present invention.

FIG. 3 is a block diagram illustrating the structure of a marker, according to an exemplary embodiment of the present invention, that has location data and control data associated therewith, the control data including selection controls and various activity controls.

FIG. 4 is a flowchart illustrating a method, according to an exemplary embodiment of the present invention, to perform localized activity with respect to digital data.

FIG. 5 is a block diagram illustrating the architecture of a digital data activity application, in the specific exemplary form of a digital image adjustment application, according to one embodiment of the present invention.

FIG. 6 is a block diagram illustrating the structure of image adjustment markers, which may be associated with one or more image adjustment layers in an exemplary embodiment of the present invention.

FIG. 7 is a user interface diagram illustrating an exemplary user interface that may be generated by the interface component of a digital data activity application, according to an exemplary embodiment of the present invention, and illustrates the placement and display of markers, in the exemplary form of “pins”, within the context of the user interface.

FIG. 8 is a user interface diagram illustrating a modification dialog box, according to an exemplary embodiment of the present invention, which may be provided by an interface component of a digital data activity application so as to enable a user to modify parameters (e.g., selection and activity parameters) associated with a marker.

FIG. 9 is a flowchart illustrating a method, according to one exemplary embodiment of the present invention, to generate a selection mask by the combination of a number of spatially restricted selection masks to generate a composite selection mask.

FIG. 10 is flowchart illustrating a method, according to an exemplary embodiment of the present invention, to perform a parametrically-controlled adjustment with respect to source image data, and to apply a selection mask, to generate destination image data.

FIG. 11 is a flowchart illustrating a method, according to an exemplary embodiment of the present invention, to perform an image adjustment activity utilizing a number of selection masks, some of which have a negative polarity associated therewith.

FIG. 12 is a user interface diagram, illustrating an audio and video editing user interface, and illustrates how an exemplary embodiment of the present invention may be utilized to perform activities in a localized manner with respect to parametrically selected portions of the audio/video data.

FIG. 13 is a diagrammatic representation of a text document, and illustrates how an exemplary embodiment of the present invention may be utilized to perform a formatting activity, in a localized manner, with respect to a parametrically selected portion of the text document.

FIG. 14 is a block diagram illustrating a machine, in the exemplary form of a computer system, to execute a set of instructions, thereby to cause the machine to perform any one of the exemplary methodologies described herein.

### DETAILED DESCRIPTION

A method and system to perform localized activities with respect to digital data are described. In the following description, for purposes of explanation, numerous specific details are set forth in order to provide a thorough understanding of the present invention. It will be evident, however, to one skilled in the art that the present invention may be practiced without these specific details.

An exemplary embodiment seeks to provide a system and method to enable a user to perform a multitude of activities (e.g., image adjustments) with respect to source digital data (e.g., vector-based or non-vector based graphics or art), in which the user has parametric control of both the activity and the portion of the source digital data to which the activity is applied. Further, one exemplary embodiment seeks to provide near real-time feedback (e.g., visual feedback) regarding the results of the parametrically-controlled activity. In other words, the effects of the activity may be communicated or observable by a user in a near real-time manner. Further, an embodiment seeks to enable a user interactively to modify parameters associated with the activity and/or the selection, so as to provide output to the user, in near real-time, showing the effects of such modifications to the activity or selection parameters.

To this end, in one embodiment, a user is able to specify location data, with respect to the source digital data, utilizing a graphical user interface via which the user can locate an icon (e.g., an activity pin) with respect to the source digital data. The activity pin may have at least two sets of controls associated therewith. A first set of controls provides a selected activity type (e.g., an image adjustment type) and an associated set of activity parameters for the selected activity type. A second set of controls provides for a parametrically-controlled selection of a portion of the source digital data, and has one or more portion selection parameters associated therewith.

As noted above, an embodiment of the present invention seeks to enable the performance of a multitude of localized activities with respect to source digital data. Accordingly, location data (e.g., associated with one or more activity markers or pins) may allow a user to specify a multitude of locations with respect to source digital data at which various activities (e.g., selective adjustments) are to be applied. Further, the activity markers may specify both the activity type, and also parametrically control the degree (or extent) of effects that result from the selected activity. For example, the degree (or extent) of activity may be controlled as to locality, both in a coordinate space and a color space, with respect to digital image data.

Further, one embodiment allows a user to modify the controls associated with a particular activity marker (e.g., an activity pin), and the parametrically-controlled portion of the source digital data, to provide a user with near real-time feedback (e.g., visual or otherwise).

In one embodiment, a marker may furthermore have a “polarity” associated therewith, and a user may be enabled to switch a polarity from positive to negative, or vice versa. A “positive” marker, in one embodiment, may identify a portion that positively contributes towards the definition of a selection mask, while a “negative” marker may negatively contribute (or subtract) from a selection mask. Consequently, in one embodiment, combinations of positive and negative markers may be utilized to create a refined composition selection mask, or to refine the portion of the digital data to which the activity is applied.

The activity markers, utilizing an associated collection of selection controls, provide a mechanism for performing a portion (e.g., region) selection, in one embodiment, based on proximity to location data for an activity marker. A user, by locating multiple activity markers with respect to source digital data, can specify an accumulation of activities to be performed with the respect to the source digital data, with each of these activities being parametrically localized in accordance with appropriate selection controls associated with each of the activity markers.

Further, in one exemplary embodiment, an activity layer is provided (e.g., as part of a digital data activity application), the activity layer being distinct from the source digital data and operatively serving to modify a representation of the source digital data. As the activity layer is distinct from the source digital data, an activity layer enables a digital data activity application to modify a representation of the source digital data in a non-destructive manner. Further, in one embodiment, a digital data activity application may enable a user to create a multitude of activity layers that may be “superimposed” so as to create an accumulation of parametrically selected portions of a source digital data and/or an accumulation of parametrically-controlled activities with respect to the source digital data.

Certain activity markers, in one exemplary embodiment, may be equipped with sensing logic so as to enable the activity markers to identify certain characteristics of source digital data at locations associated with the activity markers (e.g., at locations on digital image data at which the markers have been placed by a user). The sensing logic may, responsive to the detection of a predetermined characteristic, automatically invoke certain predetermined activities with respect to the parametrically controlled portion of the source digital data associated with the activity marker. For example, in the exemplary embodiment where the source digital data is digital image data, an activity marker may automatically determine whether a location, associated with the marker in the digital image data, is in shadow or in highlight. Depending on this determination, a parametrically-controlled adjustment with respect to a selected portion of the digital image data may be performed.

Further, in one embodiment, a predefined (or default) set of activity markers may furthermore be provided within the context of a digital data activity application, the predefined activity markers including selection and activity controls, and associated parameters, which are pre-configured to perform certain activities. Again, considering an example where the source digital data is digital image data, a “bluer-sky” marker may be defined automatically to enhance the blue color of the sky when placed on a portion of digital image data representing the sky. Similarly, a “greener-tree” marker may be provided by a digital image adjustment application. The digital image adjustment application may also enable a user to modify parameters, associated with the selection and activity controls.

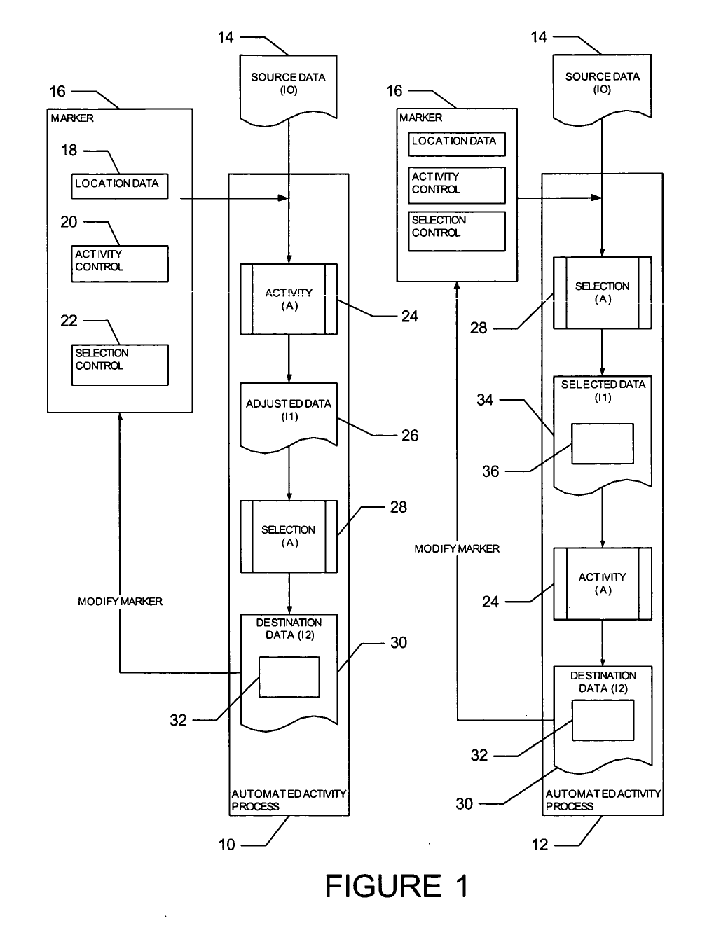

FIG. 1 is a block diagram illustrating automated processes 10 and 12, according to respective exemplary embodiments, for the performance of one or more localized activities with respect to source digital data 14. In a first embodiment, the source digital data 14 and a marker 16 provide input to an automated activity process 10. The marker 16 includes location data 18, identifying a location in the source data 14, an activity control 20 specifying an activity type and associated activity parameters, and a selection control 22 specifying a selection type and associated parameters. The activity process 10 is shown to perform an activity process 24 (e.g., image adjustment) with respect to the source data 14, in accordance with the activity control 20, to generate adjusted data 26. A selection process 28, to define a selection mask, is then performed. Effects of the activity process 24 are then localized utilizing the selection mask to generate destination data 30. Specifically, the effects of the activity process 24 are localized, by the selection mask, to a selected portion 32 of the destination data 30. The marker 16 may then optionally be modified (e.g., any of the location data 18, activity control 20 or selection control 22 may be modified) by a user or an automated process to invoke a further iteration of the automated activity process 10.

The second exemplary automated activity process 12 differs from the process 10 in that a selection process 28 precedes the activity process 24. Accordingly, the selection process 28 is shown to generate a selection mask that identifies a selected portion 36. The activity process 24 is then applied with respect to the selected portion 36, thereby to generate destination data 30, in which the effects of the activity process 24 are localized to a selected portion 32. Again, the marker 16 may be modified to invoke a further iteration of the automated activity process 12.

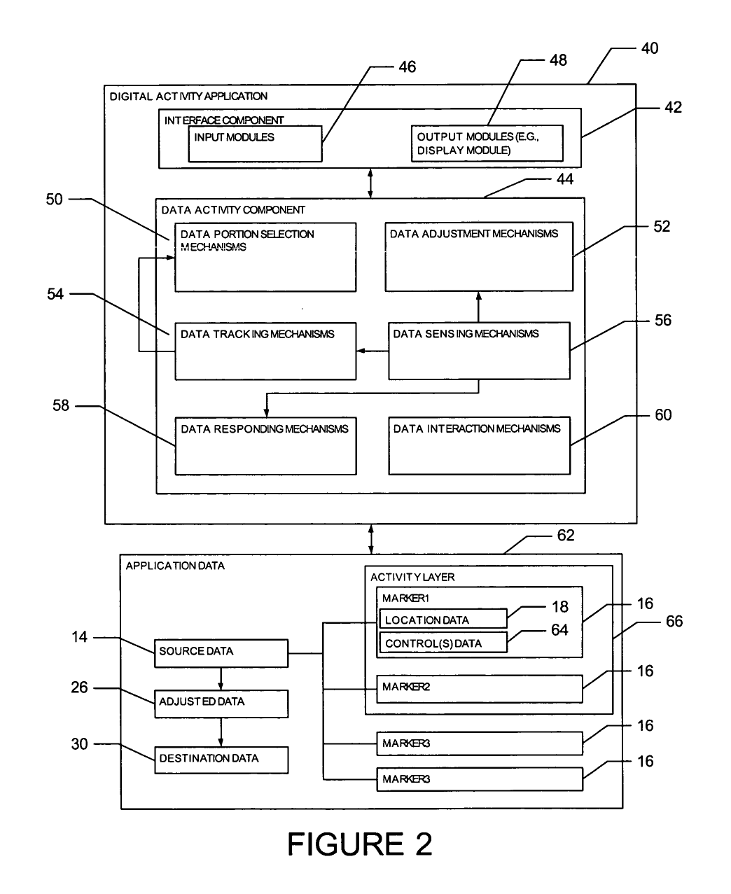

FIG. 2 is a block diagram illustrating an exemplary system, in the form of a digital data activity application 40, to perform a localized activity with respect to digital data. The activity application 40 includes (1) an interface component 42 and (2) a data activity component 44. The interface component 42 operates to receive input from, and to provide output to, a user of the activity application 40, and/or to other systems and applications. To this end, the interface component 42 includes one or more input modules 46 to receive source digital data 14 from a device or system (e.g., an audio input device, a digital camera, a video camera, a disk drive etc). The input module 46 also enables the activity application 40 to receive input, via a user interface, from a user. For example, the input module 46 enables a user to input location data 18, specifying a location with respect to source digital data 14.

The interface component 42 also includes one or more output modules 48 to provide output to one or more external devices or systems (e.g., a display device, an audio reproduction device, or a disk drive).

The data activity component 44 is shown to include selection logic, in the exemplary form of a data portion selection mechanism 50, and multiple instances of activity logic. In the exemplary embodiment, the activity logic may include data adjustment mechanisms 52, data tracking mechanisms 54, data sensing mechanisms 56, data responding mechanisms 58 and data interaction mechanisms 60, each of these mechanisms 52-60 operating to perform a specific activity with respect to source digital data 14. The effects of these activities are localized utilizing the data portion selection mechanism 50, which creates a selection mask in terms of which the effects of the activities may be localized. At a high level, the data adjustment mechanisms 52 may perform one or more adjustments (or modifications) to a selected portion of the source digital data 14. Before discussing the various exemplary mechanisms 52-60 in further detail, it is useful to consider the application data 62 that constitutes input to, and is generated as output by, the activity application 40. Specifically, the application data 62 is shown to include the source digital data 14, the adjusted data 26 (which constitutes an intermediate output of the activity application 40) and the destination data 30 (which constitutes output of the activity application 40). A collection of activity markers 16 is associated with each instance of source digital data 14, each marker 16 including location data 18 and control data 64. The location data 18 identifies a location (e.g., a two-dimensional or three-dimensional image coordinate) with respect to the source digital data 14. The control data 64 identifies one or more data portion selection mechanisms 50, as well as one or more mechanisms selected from the activity logic (e.g., the mechanisms 52-60). In one embodiment, the association between each of the markers 16 and the source digital data 14 is user-created, as a result of input received from a user via the interface component 42. However, certain markers 16 may be automatically instantiated, and associated with source data 14, as a result of activities performed by the data sensing and/or data responding mechanisms 56 and 58.

A subset of the markers 16 may furthermore be associated with an activity layer 66, as will be further described below.

Returning to the activity logic, the data adjustment mechanisms 52 may include a collection of mechanisms, identifiable by control data 64 of a marker, that perform adjustment operations with respect to the source digital data 14. The types of adjustment may depend on the types of digital data with respect to which the activity application 40 is adapted to perform activities. For example, where the activity application 40 is an image editing application, the data adjustment mechanisms 52 may specify a number of image adjustment operations. Where the activity application 40 is an audio or video editing application, the adjustment mechanisms 52 will similarly be suited to adjusting these data types.

The data tracking mechanisms 54, which may again be associated with a marker 16 via the control data 64, may operatively track characteristics associated with a particular marker 16, as well as various selection and adjustment characteristics. For example, in an embodiment in which the source digital data 14 comprises digital video data, a tracking mechanism 54 may enable a marker 16 automatically to be relocated with respect to the video data (e.g., as image content, within the video data, moves). In one embodiment, a data tracking mechanism 54 may operatively modify the location data 18 of a marker 16. Accordingly, when a marker 16 is located on particular image feature or object, a data tracking mechanism 54 provides the capability for that marker 16 to remain associated with the image feature or object as that feature or object moves through a sequence of video frames.

To implement a tracking ability, a tracking mechanism 54 may utilize initial state information (e.g., location data 18 indicating a fixed location). Control data 64 associated with a data tracking mechanism 54 may indicate if the relevant marker 16 is to be fixed at a specific location with respect to the source data 14 (e.g., it is to be fixed at an image coordinate (x,y position)). The state is set to “fixed” for an initial video frame, but set to “not fixed” for subsequent video frames, which indicates that the marker 16 is relocatable to track an underlying image, object or feature from the initial fixed frame, or from a previous image frame.

A data tracking mechanism 54 may utilize any one of a number of tracking algorithms described in published literature. For example, in one embodiment, a search window region may be defined around a location, identified by the location data 18. For each of a multitude of locations of a smaller track window, placed within the larger search window region, a “similarity measure” is calculated. The similarity measure quantifies how similar the track window is to an equal size track window placed at the location, identified by the location data 18, in either an initial frame or a previous frame. One such “similarity measure” is the negative of the mean squared difference of pixel intensity value, averaged over all color components. For the multitude of search points, that point which is the most similar (e.g., has the largest “similarity measure”) is chosen as the new “tracked location” for the video frame. Accordingly, the location data 18 may then be modified to equal the new tracked location. Accordingly, the marker 16 is moved to the new “tracked location.”

Another method of tracking uses a histogram comparison, an example of which is more fully described in the following document:

IEEE TRANSACTIONS ON PATTERN ANALYSIS AND MACHINE INTELLIGENCE, VOL. 25, NO. 5, MAY 2003 Kernel-Based Object Tracking. Dorin Comaniciu, Senior Member, IEEE, Visvanathan Ramesh, Member, IEEE, and Peter Meer, Senior Member, IEEE.

If an image in each frame of source video data is first converted to a gradient magnitude image, then the above-described tracking mechanism will be more sensitive to edges in the image. The gradient magnitude can be the root mean square of the result of applying a horizontal Sobel photo and a vertical Sobel filter. Exemplary Sobel filters are more fully described in the following document:

R. Gonzalez and R. Woods, Digital Image Processing, Addison Wesley, 1992.

The control data 64 of a marker 16 may additionally reference one or more data sensing mechanisms 56. In one embodiment, a data sensing mechanism 56 may enable a marker 16 to “sense” a local environment. For example, where the source digital data comprises video or image data, if the associated marker 16 is placed on an eye, the data sensing mechanism 56 may enable the marker 16 to detect the presence of an eye feature, and respond accordingly. The response may be an alert to a user of the activity application 40 that the marker 16 has been located on an eye, and perhaps that eye correction adjustment (e.g., red eye correction, whitening of cornea, saturating iris, etc.) should be applied. Alternatively, such adjustments may be made automatically. To this end, the data sensing mechanisms 56 are shown to be communicatively coupled to the data adjustment mechanisms 52. In the event that, for example, an eye is detected, the data sensing mechanism 56 may invoke an appropriate image adjustment mechanism 52 in an automated fashion to make an image adjustment.

A further data sensing mechanism 56 may enable a marker 16 to sense when an underlying image, feature or object changes. For example, a data sensing mechanism 56 may retain stored image data from a window around a location identified by the location data 18. The data sensing mechanism 56 may then compare this window to a selected video frame, for example, with corresponding window image data, from a current video frame on which the marker 16 is located. Sensing may consist of measuring the average squared difference according to the following equation:
sensation=<[I1(r)−I2(r)]²> (0)
where I1(r) is image intensity or color data at location r from one video frame and I2(r) is the data at the same relative location in another frame, and <. . . >indicates an average value taken over all pixels located within the window. In addition to taking the average difference in squared image intensity (e.g., including color) values, the average may incorporate the difference in squared gradient values. This may replace the intensity difference or may supplement it with an associated weight.

The control data 64 of a marker 16 may also associate one or more data responding mechanisms 58 with a particular marker 16. The data responding mechanisms 58 may, as shown in FIG. 2, be communicatively coupled to a data sensing mechanism 56, and receive input from a data sensing mechanism 56. As noted above, for source video data, where a data sensing mechanism 56 detects an image change (e.g., greater than a predetermined threshold), the data sensing mechanism 56 may invoke a response by the marker 16. Such a response, in one embodiment, is provided by one or more data responding mechanisms 58. For example, the response issued by a data responding mechanism 58 may be an alert to the user. Alternatively, the response may be a signal that is sent to the activity application 40, for the purpose of coordinating image modifications. Alternatively, a response signal may be sent as a message (e.g., an e-mail, a phone text message, a phone message, or an electronic message of another sort) directed towards another computer program or device. A data responding mechanism 58 may further send a message to components of another marker 16 that is associated with the subject source digital data 14, or to a marker 16 associated with a different source digital data 14 (e.g., source digital data of a different type).

The control data 64 of a marker 16 may furthermore associate one or more data interaction mechanisms 60 with the relevant marker 16. In one embodiment, the data interaction mechanisms 60 enable multiple markers 16, associated with common or different source digital data 14, to interact. For example, markers 16 may interact to maintain a specified spatial arrangement. Consider an example in which the source data 14 is a video data, comprising a video clip monitoring a house. A marker 16 is then located with respect to the video clip. Utilizing an appropriate data sensing mechanism 56, the marker 16 analyzes the image data (or other document data) in the vicinity of a specified location for the purposes of responding in a predetermined manner, as dictated by a data responding mechanism 58. The sensing operation may be to determine if the marker 16 is located on a human face, in which case the marker 16 may set (or select) a data adjustment mechanism 52 to make an appropriate skin tone correction. Similarly, if the marker 16 is located on sky, it may select appropriate “blue sky” adjustment mechanism 52.

In the monitoring example, in the event that the data sensing mechanism 56 of the marker 16 senses a change in local scene content (e.g., notices that the door has been opened), an associated data responding mechanism 58 may be invoked to send a message to other markers 16, associated with the image, or to markers 16 associated with a different video clip. For example, once a specific marker 16 detects that the door has been opened, a marker 16 located near a vault or jewelry box may be instantiated and/or activated to begin sensing operations, utilizing a data sensing mechanism 56, to detect or analyze faces (e.g., black ski masks) within the vicinity, and to generate an appropriate notification (e.g., an e-mail message to a homeowner) or to activate an alarm.

While the mechanisms 52-60 have above been described with reference primarily to video data, it will readily be appreciated that these mechanisms may equally be applied to other types of digital data. For example, the source digital data 14 may be audio data. In this case, one or more data tracking mechanisms 54 may track a specific audio feature or object within the audio data (e.g., a specific voice, instrument, frequency, tone, etc.). Similarly, a data sensing mechanism 56 may operate to sense a particular characteristic of the underlying audio data so as to enable the tracking. The sensing mechanism 56 may also then invoke one or more adjustment mechanisms 52 to adjust a sensed (and possibly tracked) audio feature or object in an underlying audio track. Similarly, a data responding mechanism 58 may provide an alert, or perform some other action, in response to a detected condition. For example, where the audio data comprises surveillance information, a sensing mechanism 56 may be configured to detect the voice of a particular individual. Responsive to detecting such a voice, the data sensing mechanism 56 may invoke a data adjusting mechanism 52 to adjust the audio data (e.g., by enhancing the sensed voice), and may also invoke a data responding mechanism 58 to provide a user with an alert indicating that the relevant voice has been detected.

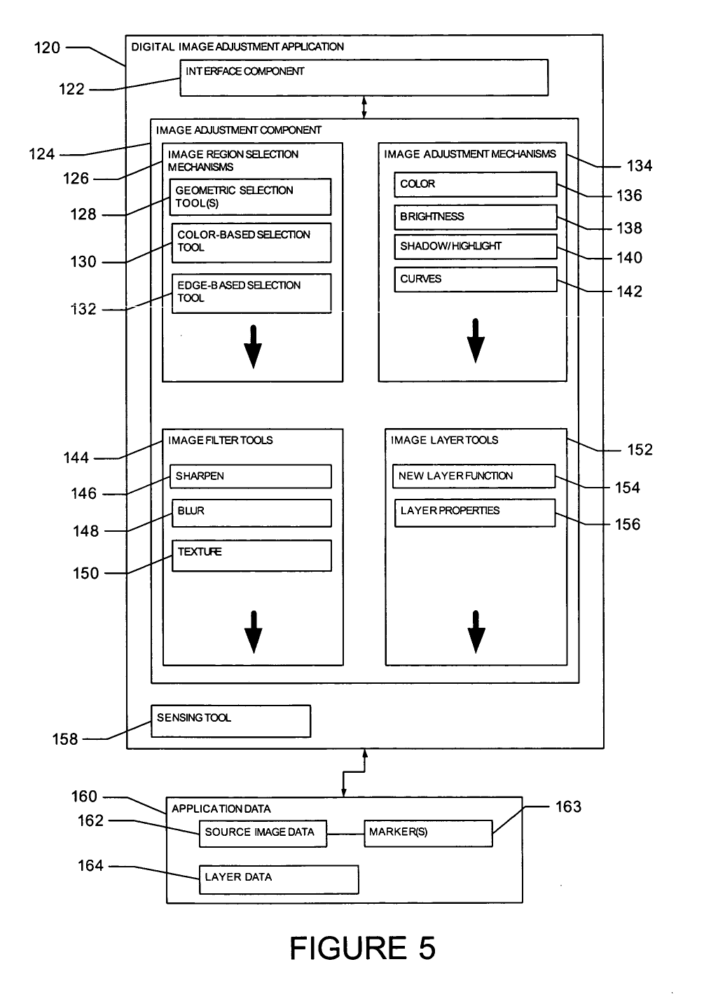

A more detailed discussion regarding how an exemplary embodiment of the present invention may be utilized with respect to still image data is provided below, with reference to FIGS. 5-11.

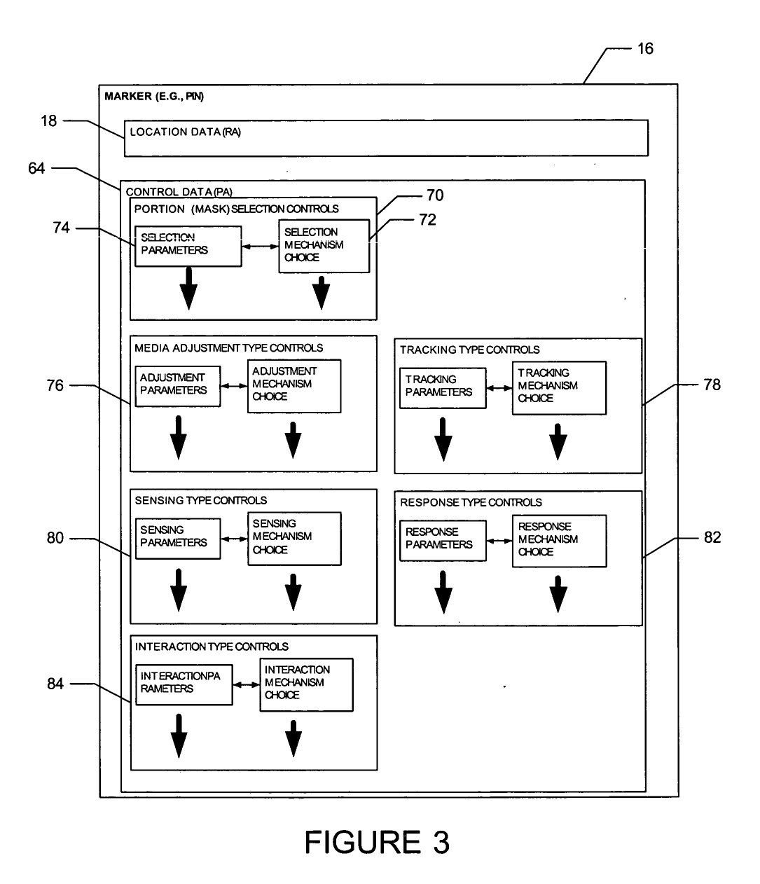

FIG. 3 is a block diagram providing further detail regarding the structure of a marker 16, according to an exemplary embodiment of the present invention. As mentioned above with reference to FIG. 2, a marker 16 may include location data 18, identifying a location within source digital data 14 with which the marker 16 has been associated either by a user or an automated process (e.g., by a data sensing mechanism 56). The marker 16 is also shown to include control data 64, which includes one or more of the controls. The exemplary marker in FIG. 16 is shown to include (1) portion (or mask) selection controls 70, which include a selection mechanism choice 72 (e.g., the identification of one of a number of data portion selection mechanisms 50 supported by the activity application 40), and (2) one or more parameters 74 associated with the selection mechanism choice 72. The data portion selection mechanism 50, identified by the selection mechanism choice 72, utilizes the selection parameters 74 in order to perform a parametrically-controlled selection of a portion of the source digital data 14 to which the effects of one or more activities are to be localized. The control data 64 is shown to include a number of activity controls 76-84, each of which includes an appropriate mechanism choice, and associated parameters. It will be noted that, in the exemplary embodiment, the controls 76-84 correspond to the various activity mechanisms 52-60 described above with reference to FIG. 2. Accordingly, each of the mechanism choices identifies one or more mechanisms from the mechanisms 52-60 supported by the activity application 40. The associated parameters are utilized by the chosen mechanisms to perform their respective activities.

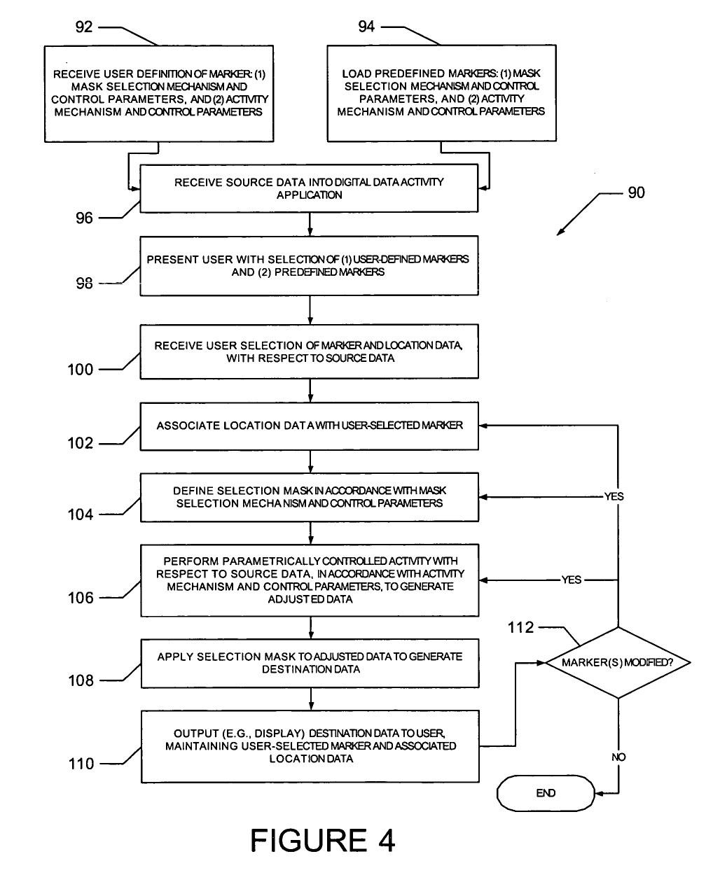

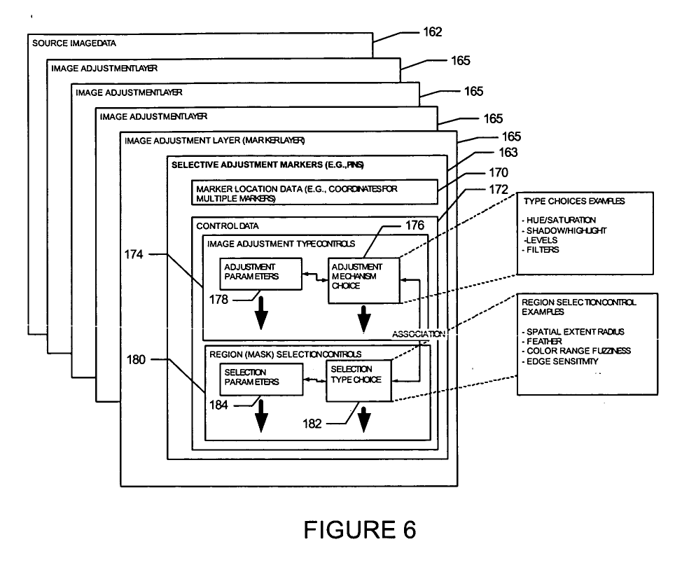

FIG. 4 is a flow chart illustrating a method 90, according to an exemplary embodiment, to perform a localized activity with respect to digital data. In one embodiment, the method 90 may be performed by the activity application 40, as discussed above with reference to FIG. 2, utilizing the discussed application data 62. The method 90 commences at blocks 92 and 94. Specifically, at block 92, the activity application 40 may, via an input module 46 of the interface component 42, receive a user definition of one or more markers 16. To this end, a user may define control data 64 to be associated with the marker 16. Location data 18 is provided later, once the marker 16 is associated with a particular location on subject source digital data 14. The control data 64 may include user selection of a particular data portion selection mechanism 50, and associated parameters 74, as well as the identification of one or more activity mechanisms 52-60, and associated control parameters. Examples of such data portion selection mechanisms, activity mechanisms, and associated control parameters with respect to image data, are discussed below with reference to FIG. 6.

At block 94, the activity application 40 may also load a collection of predefined (or preconfigured) markers 16, each predefined marker 16 having a predefined data portion selection mechanism 50, one or more activity predefined mechanisms 52-60, and associated control parameters. For example, such a predefined marker 16 may be the exemplary “blue-sky” marker 16 discussed above with reference to FIG. 2.

At block 96, source data 14 is received into the digital data activity application 40. For example, the application 40 may retrieve the source data 14 from a disk drive associated with a computer system on which the application 40 is executed. Alternatively, the application 40 may received the data from an external device (e.g., a digital camera, a video camera, a microphone etc.).

At block 98, the application 40 presents the user with a selection of markers (e.g., user-defined markers 16 and predefined markers 16). Specifically, the interface component 42 may present a menu displaying marker icons associated with a collection of markers 16, so as to enable user selection of one or more of these markers 16. In one embodiment, the marker icons that are presented may differ from each other according to the selection and/or activity mechanisms associated with an underlying marker 16.

At block 100, the application 40, via the interface component 42, receives a user selection of a specific marker 16, as well as location data 18, indicating a location with respect to the source data 14. The location data 18 may be received by the generation of a user interface, displaying a representation of the source data 14, relative to which the user can locate a marker icon representing the marker 16. For example, the user may be enabled, via the user interface, to “drag-and-drop” a marker icon to a location on a displayed digital image. In one embodiment, the interface component 42 may provide a “snap to” feature, which identifies a feature of displayed digital image data that is proximate to a location at which a user may have dropped a marker icon, and then moves of the marker icon to the identified feature. In an alternative audio embodiment, the user may be able to drag-and-drop an appropriate marker icon onto a track representation of an audio or video data. In yet another embodiment, the user may drag-and-drop a marker icon onto a specific text, or other objects, displayed within a document, where the activity application 40 is a word-processing application. By sensing the location at which a user has placed the marker icon, the activity application 40 is able to determine and receive the location data 18.

At block 102, the application 40 associates the location data 18 with the appropriate marker 16, for example by storing the location data 18 within the context of a marker 16.

With respect to blocks 100 and 102, the user may be able to select and locate, with respect to a representation of the source data 14, multiple markers 16, each potentially being of a different type and having different characteristics.

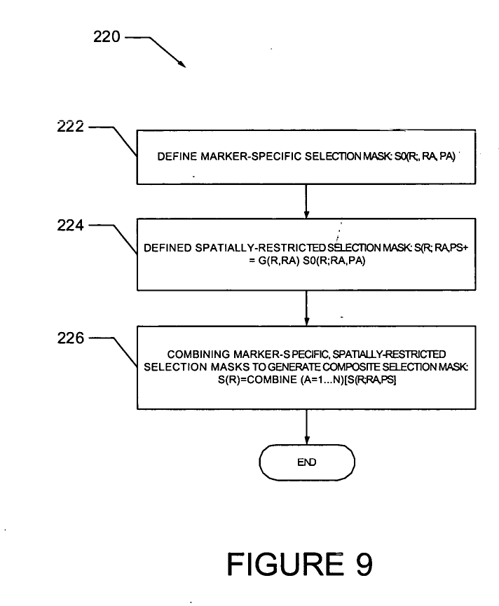

At block 104, the application 40 defines a selection mask with respect to the source data 14, utilizing the portion selection mechanisms 50, and associated selection parameters 74, of each of the selected markers 16. In the case where multiple markers 16 have been user-selected, a composite mask selection is defined at block 104 according to any one of a number of combination techniques. A discussion regarding one such exemplary method is provided below with reference to FIG. 9.

At block 106, the application 40 performs a parametrically-controlled activity (e.g., an adjustment, tracking operation, sensing operation, responding operation, or an integration operation) with respect to the source data 14, in accordance with the selection mechanism choices, and associated control parameters, for each of the markers 16, thereby to generate the adjusted data 26. Specifically, in one embodiment, the parametrically-controlled activities may be performed globally with respect to the source data 14 in order to generate the adjusted data 26.

At block 108, the application 40 applies the selection mask, defined at block 104, to the adjusted data 26 in order to localize the effects of the one or more parametrically-controlled activities performed at block 106. The output of this operation is the destination data 30, within which the effects of the parametrically-controlled activity have been localized to a selected portion 32.

At block 110, the application 40, via the output modules 48 of the interface component 42, outputs (e.g., displays, produces an audio representation etc.) the destination data 30 to a user (or further external computer system), while maintaining the user-selected marker(s) 16, and associated location data. A user-selected marker 16, and associated location data, persists (or is maintained) subsequent to the parametrically-controlled activities performed at block 106, the application of the selection mask at block 108, and the output of the destination data 30 at block 110.

At decision block 112, a determination is made by the application 40 whether the user has, via the interface component 42, modified any one or more of the markers 16. In an alternative embodiment, an automated process (e.g., a further marker 16 or an external application) may also modify a marker 16. Modifications to the one or more markers 16 may include a re-location of a marker icon with respect to the source data 14. For example, a user, utilizing an appropriate interface, may move a marker icon from an initial location to a further location with respect to a representation of the source data 14. Alternatively, the control data 64 may have been modified. For example, the selection mechanism choice 72, associated with a portion selection control 70, may have been modified. Alternatively, one or more selection parameters 74 of a selection control 70 may have been modified. Further, an activity control may have been modified. For example, the activity mechanism choice, or one or more associated parameters, may have been modified.

A user interface, generated by the interface component 42, allows a user to select (e.g., by a “double click” mouse operation) an appropriate marker icon, responsive to which a modification menu is displayed. The modification menu allows the user conveniently to input an alternative selection by specifying a different selection mechanism choice 72, and/or inputting a different selection parameter 74. A dialog box, also generated and displayed in response to user selection of an appropriate marker icon, may enable a user to make an alternative mechanism choice with respect to any one of a number of activity controls, and also to modify or replace control parameters associated with an appropriate mechanism.

Having determined, at decision block 112 that one or more markers 16 have been modified, the method 90 loops back to either block 102, 104 or 106, depending on the modifications that have been made with respect to a marker 16. For example, where the location data 18 has been modified, the method loops back to block 102. Where a selection mechanism choice 72, and/or a selection parameter 74, has been modified, the method loops back to block 104. Where an activity mechanism choice, and/or an associated control parameter, has been modified, the method 90 may loop back to block 106.

The method 90 enables a “live”, or near real-time, capability to a user with respect to the modification of an activity (e.g. an updating on modification) performed with respect to source data 14 (e.g., a digital image). Because the location data 18 and the control data 64 are maintained subsequent to the operations performed at blocks 104-110, and the user is able selectively to modify a subset (or even all) of this data, the user is conveniently able to perceive the effects of a modification of a mechanism choice, or a control parameter, while other mechanisms and control parameters are maintained. Accordingly, the local adjustments may be viewed as being “live”, and can be performed in any order, with prompt feedback (visual or otherwise) with respect to a representation of the destination data 30.

Again, while the method 90 is described above, at block 106, as performing one or more parametrically controlled activities on a global basis with respect to the source data 14and subsequently applying a selection mask to localize the effects of such activities, in an alternative embodiment the selection mask may be applied to the source data 14 prior to the performance of a parametrically controlled activity, whereafter the effects of that parametrically controlled activity may be localized to a portion of the source data 14 defined by the selection mask.

FIG. 5 is a block diagram illustrating an exemplary embodiment of an activity application 40, in the form of a digital image adjustment application 120. The adjustment application 120 enables a user to perform various editing and modification operations with respect to digital images. One example of such an application is the ADOBE® PHOTOSHOP® application.

The adjustment application 120 is shown to include an interface component 122, and an image adjustment component 124. The image adjustment component 124 in turn incorporates a number of mechanisms, namely a collection of image region selection mechanisms 126, a collection of image adjustment mechanisms 134, a collection of image filter tools 144, and a collection of image layer tools 152. The image region selection mechanisms 126 assist a user in selecting a region of a digital image to which to apply any one or more of the image adjustment mechanisms 136 or the image filter tools 144. Exemplary region selection mechanisms 126 include geometric selection tools 128, color-based selection tools 130, and edge-based selection tools 132. In one embodiment, any one or more of the selection mechanisms 128-132 may be associated with a marker 16. For example, the selection mechanisms 128-132 may enable a marker 163 to perform a parametrically-controlled selection of a region of a digital image, with respect to a marker location identified by location data 18, utilizing measures of the spatial extent radius and further amount, color range, fuzziness, and edge sensitivity with respect to the marker location.

Exemplary image adjustment mechanisms 134 are shown to include color, brightness, shadow/highlight and curve mechanisms 136, 138, 140 and 142. Again, each of the mechanisms 136-142 provides an example of an activity mechanism that may be applied with respect to source data 14.

The exemplary image filter tools 144 include sharpen, blur and texture tools 146, 148 and 150. These also provide examples of activity mechanisms that may be applied with respect to source data 14.

The image layer tools 152 include a “new layer” function 154, and a layer properties function 156. As noted above, image layers provide examples of activity layers that may be applied with respect to source data 14, so as to enable activities to be applied with respect to a representation of underlying source data 14 in a non-destructive manner. In one embodiment, the image layer tools 152 may enable the creation of a layer (e.g., a marker layer) that is specifically adapted to accommodate one or more markers 163 to be applied with underlying image data. A selection mask, associated with the marker layer, may be built, utilizing a set of markers 163 and their associated parameters. A user is furthermore able to create a number of marker layers, each marker layer accommodating markers 163 having a certain common characteristic. Accordingly, unique sets of markers 163 may be associated with each of a number of distinct image layers. This feature allows a user conveniently to activate and deactivate such a group of markers 163 that are associated with a particular layer by activation and deactivation of the relevant image adjustment layer.

The image adjustment application 120 may also include sensing logic, in the exemplary form of one or more sensing tools 158, that is configured to sense predetermined characteristics of an image feature or object within source image data 162, in a manner described, for example, above with reference to FIG. 2.

The application data 160 includes, inter alia, the source image data 162, with which one or more markers 163 are shown to be associated. The application data 160 also includes layer data 164 that may store an association of a subset of markers 163 with an image adjustment layer.

FIG. 6 is a block diagram providing a conceptual representation of the application of multiple image adjustment layers 165 to source image data 162, according to an exemplary embodiment. As shown, any number of image adjustment layers 165 may be overlaid on a representation of the source image data 162 to modify a representation thereof. FIG. 6 illustrates the top image adjustment layer 165 as being a marker layer, having one or more markers “contained” or residing within the context of the marker layer. The markers 163 are shown to include location data 170 (e.g., the two-dimensional or three-dimensional coordinates with respect to the image data 162) and associated control data 172. The control data 172 in turn includes one or more image adjustment type controls 174, each indicating an adjustment mechanism choice 176 (e.g., brightness, shadow/light, levels, filters etc.), and one or more adjustment parameters 178 associated with each adjustment mechanism choice. For example, where the adjustment mechanism choice 176 indicates brightness, an associated adjustment parameter 178 may be a numeric value indicating whether this adjustment tool is to be negatively or positively applied, and also the extent to which the tool is to be positively or negatively applied.

The control data 172 also includes region (or mask) selection controls 180, including one or more selection type choices 182, and one or more selection parameters 184 associated with each such selection type choice 182. For example, a specific selection type choice 182 may indicate a spatial extent radius, feather, color range fuzziness, or edge sensitivity selection type, for example. Each of the selection type choices 182 has an associated selection parameter 184 associated therewith so as to enable a parametrically-controlled application of the selection type choice 182.

In one embodiment, each marker 163 may furthermore have one or more “toggle” or switch parameters associated therewith to enable a user selectively to activate and deactivate an appropriate activity mechanism and/or selection mechanism. To this end, a marker icon for a particular marker 163 may provide a visual representation of one or more “toggle” switches that enable a user to activate or deactivate an activity and/or selection mechanism associated with the underlying marker 163. In a further embodiment, switch parameters associated with a marker 163 may allow an activity or selection mechanism to be positively applied, negatively applied, or neutrally applied.

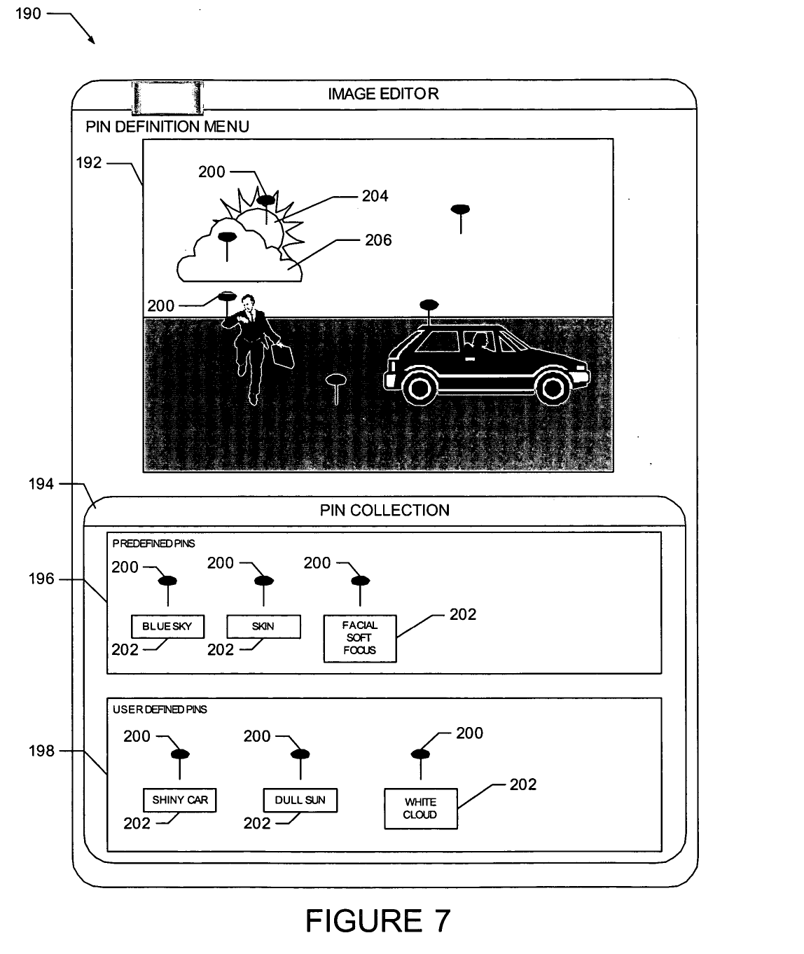

FIG. 7 is a user interface diagram illustrating an image editor user interface 190, according to an exemplary embodiment, that may be generated by the interface component 122 of the digital image adjustment application 120. The image editor user interface 190 may present various menus (not shown) that allow a user to perform image adjustment (or modification) operations with respect to digital image data 162, a representation 192 of which is displayed within the interface 190. The image editor user interface 190 further presents a user with a selection of image adjustment markers icons 200, which in the exemplary interface are conveniently termed “pins”, in a pin collection menu 194. The selection of marker icons 200 represents underlying predefined markers 196, as well as user-defined markers 198.

The menu 194 presents the marker icons 200 together with appropriate descriptor information 202. While the marker icons 200 are shown in FIG. 7 to be uniform, in alternate embodiments the marker icons 200 may vary, depending on the parametrically-controlled selection activity, and/or the parametrically-controlled image adjustment activity, associated with an underlying marker 163. Further, as described above, each of the marker icons 200 may include a graphical “switches” that allow an activity and/or selection mechanism associated with an underlying marker to be positively, negatively or neutrally applied.

The image editor interface 190 conveniently allows a user to “drag-and-drop” a marker icon 200, from within the menu 194, to a location within the image representation 192, and in this manner to input location data 170, to be associated with an instantiation of the underlying marker 163, to the image adjustment application 120. Specifically, in an exemplary embodiment, the (x, y) coordinates of the location within the representation at which a user locates a particular marker will be recognized, and stored, by the application 120 as location data 170.

Upon the location of an appropriate marker icon 200 within the representation 192, the operations described above with respect to blocks 102-110 of FIG. 4 are automatically and sequentially performed. In other words, the user-input of the location data 170 invokes the image adjustment and region selection (e.g. masking) activities associated with the underlying marker 163. For example, consider that a user may regard the sun image feature 204, as an example of an image feature or object, as being too bright within the representation 192. Accordingly, the user may drag-and-drop the “dull sun” marker icon 200 to identify a location anywhere within the sun image feature 204. Responsive to this “drag-and-drop” event, the image adjustment application 120 will receive as inputs (x, y) coordinates of a location within the sun image feature 204. An image adjustment mechanism (e.g., the brightness mechanism 138) will be automatically be invoked as a result of an association with the underlying “dull sun” marker 163, and will reference an associated selection parameter 184 to globally reduce highlighting across the digital image data 162.

The image adjustment application 120 will then define a selection mask, in accordance with a selection mechanism (e.g., the color-based selection tool 130).The defined selection mask (e.g., identifying the edges of the sun image feature 204) will then be applied to localize the highlight-reducing effects of the brightness mechanism 138 to the sun image feature 204.

In a similar manner, the user may place the “white cloud” marker icon 200 at any location within a cloud image feature 206 to likewise perform a parametrically-controlled adjustment, the effects of which are parametrically localized to the cloud image feature 206.

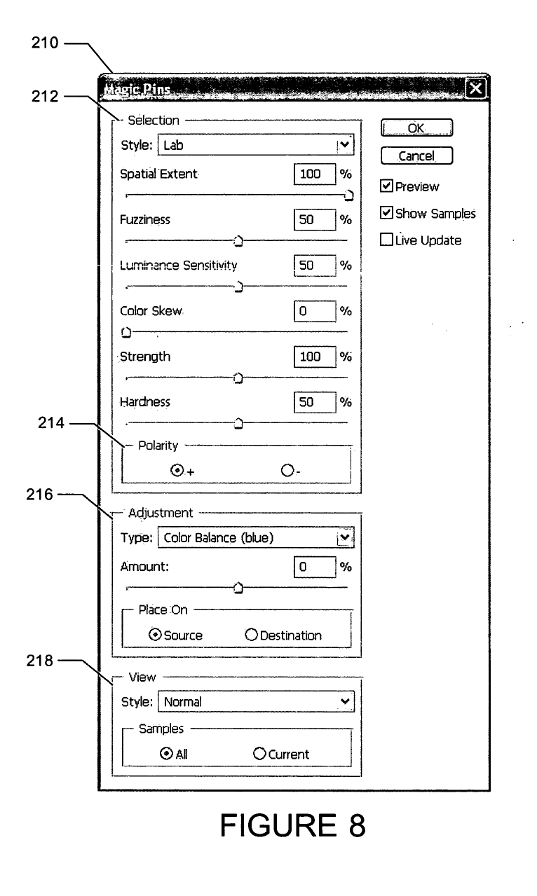

Having performed some initial image adjustment operations, in the manner described above, the user may then decide that the localized effect with respect to the sun image feature 204 is not adequate. For example, the sun image feature 204 may still be too bright for the user's liking. Accordingly, the user is now presented with the opportunity of modifying the control parameters associated with the marker 163 located on the sun image feature 204. The image editor user interface 190 enables a user to select a marker icon 200, already located within the representation 192, for example by double clicking on the relevant marker icon 200, responsive to which the image editor user interface 190 invokes a parameter modification dialog box 210. An example of such a dialog box 210 is provided in FIG. 8. This dialog box 210 may also be invoked from other menus (not shown) provided by the image editor user interface 190. As shown, the parameter modification dialog box 210 includes a region selection interface 212, utilizing which a user may modify a selection mechanism choice 182, as well as any one of a number of selection parameters 184 associated with the selection mechanism choice 182. Conveniently, the region selection interface 212 provides sliders that a user may utilize to vary a collection of selection parameters 184. The region selection interface 212 furthermore allows a user, utilizing polarity radio buttons 214, to specify a polarity with which the selection mechanism choice 182 will be applied with respect to the representation 192.

The dialog box 210 further includes an adjustment selection interface 216, utilizing which a user may specify an adjustment mechanism choice 176, and also input an adjustment parameter 178 associated with that choice. Again, a slider is conveniently provided within the selection interface 216 to facilitate input of an adjustment parameter 178.

A view selection interface 218 allows a user to define a view. The choice of view determines the form with which the source data is presented to the user. For image data, the view choices may include 1) the adjusted image data, 2) the selection mask only, presented as an image (in black and white for example), 3) ruby lith, in which the adjusted image data is blended with a ruby red (or other color of the user's choice) constant color according to the strength of the selection mask, 4) a transparency mode in which the adjusted image is blended with transparency squares according to the strength of the selection mask, 5) an opacity mode similar to 4) but using the complement (255—mask) of the selection mask.

It should be noted that, responsive to a modification of the control data 172 utilizing the dialog box 210, the representation 192 will be dynamically, and in near real-time, updated to reflect the effects of the user input provided via the dialog box 210. For example, where a selection type choice 182, or an associated selection parameter 184, is modified, the selection mask defined thereby will be dynamically modified, and the results of that modification dynamically and automatically depicted within the image editor user interface 190. Similarly, where the adjustment mechanism choice 176 or an associated parameter 178 is varied, the effects of these modifications will be dynamically reflected in the representation 192 of the digital image data 162 as displayed by the image editor user interface 190. Accordingly, utilizing the dialog box 210, a user is able to modify the control data 172 until the localized effects of a particular adjustment are to the user's satisfaction.

In addition to modifying the control data 172, for example utilizing the dialog box 210, a user is able to modify the location data 170. For example, a user may relocate a marker icon 200, within the context of the representation 192. Responsive to this relocation, the parametrically localized and parametrically-controlled effects of an adjustment are automatically applied with respect to a new location identified by the re-located marker icon 200. Again, these effects will occur in near-real time, responsive to the relocation event.

Further details regarding specific and exemplary implementations of the selection mask definition and selection mask application operations, as described above with reference to blocks 104 and 108 of FIG. 4, will now be provided. These exemplary implementations are described with respect to parametrically-controlled activities, in the form of image adjustment activities. It will nonetheless be appreciated that the principles of these exemplary implementations may be applied with respect to other parametrically-controlled activities performed with respect to other types of source digital data 14.

As noted above, a parametrically-controlled selection of a selected portion of source digital data 14 is performed utilizing a marker location with respect to the source digital data 14. In one embodiment, the selection is further determined by a set of continuous or discrete selection parameters 74, associated with a selection mechanism, identified by a selection mechanism choice 72. Examples of selection mechanisms that are provided with respect to image data may include the “Magic Wand” tool, the Color Range tool (with its associated Fuzziness parameter) and the Marquee selection tool (with an associated feather parameter), provided in the ADOBE® PHOTOSHOP® application. Selection parameters 74, such as feather selection strength, feather amount and expansion and contraction amount, can generally be applied to a number of selection mechanisms, while other selection parameters may be specific to an associated selection mechanism.

FIG. 9 illustrates a method 220, according to an exemplary embodiment, to produce a selection mask (S0) for a specific marker (a). The method 220 commences at block 222, with the definition of a marker-specific selection mask (S0) as follows:
S0(r; ra, pa) (1)
where:
S0 is the marker-specific selection mask,
r is a spatial location,
ra is a “pin” (or marker) location, and
pa is a selection control parameter.S0 may be independent of ra, in which case it is termed a global selection mask. One such example is a color range selection mask in which S0(r;
p) is large (near 1) when the color at location r is similar to a designated color, c0, and is smaller for more differing colors. An example is:
   S0(r; p)=exp(−k[c(r)−c0]ˆ2),
   where k is a parameter that controls the color fuzziness.

For a floating-point mask, the above statement has a value of 1 for fully selected regions, and a value of 0 for non-selected regions. Spatial locations r for which values lie between 0 and 1 are partially selected (e.g., for 8-bit masks, the range is 0 to 255, and for 16-bit masks, the range is from 0 to 65535). The parameters that control the selection are, as stated above, designated by pa. In addition, the selection mask, (S0) may depend on the “pin” location, ra. Note that r=(x, y) is a two-dimensional image coordinate. In an embodiment in which a three-dimensional image is adjusted, then the image coordinate may be three-dimensional (e.g., x, y, z).

Returning to FIG. 9, at block 224, a spatially restricted selection mask, S(r; ra, ps), is defined. The selection mask seeks to localize the selection of a selected portion of source digital data 14 to a region in the vicinity of a marker (e.g., pin) location. This may be done in several ways. One approach is to modulate a global selection by a function that is unity at the marker location, and degrades as one moves further away from the marker location. For example, g(r, ra) is one such function. This function has a value of unity when the spatial location, r, is equal to the marker location, ra. In other words:
g(ra, ra)=1 (2)
As the distance from the marker location, |r-ra| increases, the function decreases.

A typical such function is:
g1(r, ra)=exp(−k(r−ra)ˆ2) (3)
where:
k=1.0/(2 sigmaRˆ2), and
sigmaR is a measure of the spatial extent of the marker's selection.

SigmaR may be adjusted by a user to control the region of influence of a marker. In one implementation, the user may have control over a slider that ranges in value from 0 to 1; when the value is 0, sigmaR is set to 0, and when the value is 1, sigmaR is set to the image data width or height (or the larger of the two). For this example let a slider value, vr, range from 0 to 1. The larger of the image height or width is, a. Then:
SigmaR=a vr.

Another related function,
g2(r, ra)=exp(−k(r−ra)ˆ2): if a<½ (4)
=2a−1+(2−2a)exp(−k(r−ra)ˆ2): if a>=½ (5)
is such that it approaches a constant value of unity as, a, approaches 1. This provides a completely global selection when, a, is 1, and more localized selections for smaller values of, a.

Yet another example is:
g3(r, ra)=sigmoid ((R−|r−ra|)/sigmaR) (6)
with sigmoid(x)=1/(1+exp (−x)).
This function allows independent control of the radius of influence, R, and the steepness of the falloff, sigmaR (the feather amount).

The above functions g1, g2, and g3 each have the property that they are cylindrically symmetrical about a marker location. However, this is not necessary. For example, it may be useful to modulate the spatial profile by a linear gradient:
g4(r, ra)=g3(r, ra)(1+s.(r−ra)) (7)
where:
s is a two-dimensional vector pointing in the direction of the gradient, and
   s.(r−ra)=sx(x−xa)+sy(y−ya) (8)
   Given the global selection mask, S0, and the spatial restriction function, g, a spatially restricted selection mask can be defined as:
   S(r; ra, ps)=g(r, ra)S0(r; ra, pa) (9)

Returning again to the method 220 of FIG. 9, at block 226, the marker-specific, spatially restricted selection masks, associated with multiple markers, are then combined to generate a composite selection mask, S(r). Here, the accumulating effects of multiple markers 163 are considered.

Consider that each marker 163 produces a selection mask:
S(r; ra, pa) (10)
where:
a=1, 2, . . . N numbers the pins, and
N is the total number of pins.

Here, ra is the location of the a'th marker 16 and pa is the set of selection parameters 184 for the relevant marker 16. A composite selection mask, S(r), may be formed by combining the contributions of each of the individual selection masks, associated with each of the markers 163, as follows:
S(r)=Combine(a=1 . . . N)[S(r; ra, pa)] (11)

The combination may, in one embodiment, be implemented by simple addition of all of the contributions, with a final threshold at the end to ensure that the resultant mask values do not exceed unity:
Sum=Sum (a=1 . . . N)[S(r; ra, pa)] (12)
=S(r; r1, p1)+S(r; r2, p2)+. . . +S(r; rN, pN) (13)
S(r)=sum if sum<1, and =1 otherwise.
Define a function limit(x) to be x if 0<=x<=1, 0 if x<0 and 1 if x>1. Then
S(r)=limit(Sum(a=1 . . . N)[S(r; ra; pa)]) (14)

Alternatively a combination may be implemented pairwise, including the effect of one marker 163 at a time. Exemplary code to perform such a pairwise combination is provided below:
//Add Magic Pin Selections
Initialize S(r) to be 0 everywhere,
For (a=1; a<=N; ++a)
S(r)=limit(S(r)+S(r; ra, pa))
   The two combination approaches, discussed above, are equivalent as the resultant selection mask, S(r), is always non-negative. One further exemplary combination technique may utilize a fuzzy exclusive-or operation, exemplary code to implement this combination option being provided below:
//Combine Magic Pin Selections Using Fuzzy xor
Initialize S(r) to be 0 everywhere;
For (a=1; a<=N; ++a)
S(r)=S(r)+S(r; ra, pa)−S(r) S(r; ra, pa).

An embodiment of the present invention also proposes associating a polarity parameter with a marker 163. A polarity parameter, ea, may be assigned to each marker 163. This polarity value can, in the exemplary embodiment, take one of two values, namely +1 or −1. Negative values allow for the subtraction of a marker's contribution, while positive values cause an addition of the marker's contribution. Both negative and positive markers 163 may be utilized to shape a selection mask.

In one embodiment, to combine “polar” markers 163, the above-described combination procedure can be generalized to include subtraction when the polarity of a marker 163 is negative (e.g., ea =−1):
//Combine Polar Magic Pin Selections
S(r)=limit (Sum (a=1 . . . N) [ea S(r; ra; pa)]).
   or
Initialize S(r) to be 0 everywhere;
For (a=1, a<=N; ++a)
S(r)=limit(S(r)+ea S(r; ra, pa)).

The latter procedure is not equivalent to the first, and depends on the ordering of a set of markers 163.

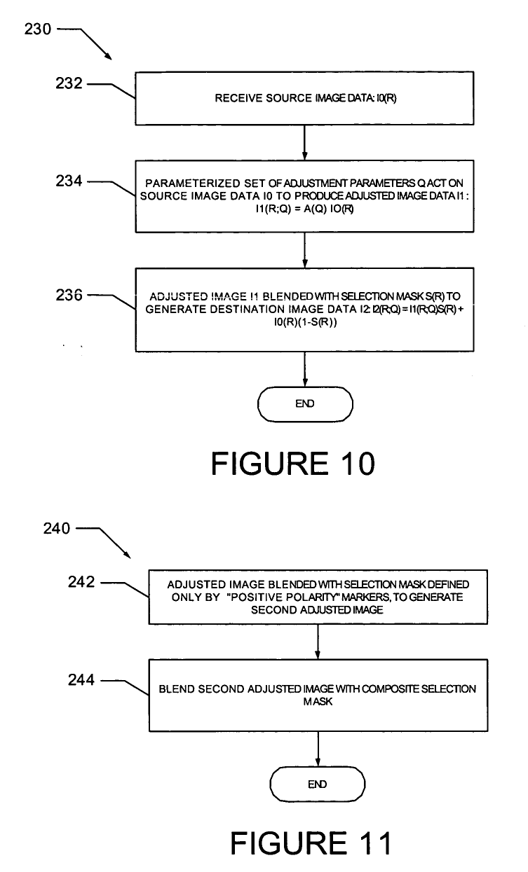

FIG. 10 is a flowchart illustrating a method 230 according to an exemplary embodiment to perform a parametrically controlled activity (e.g., an image adjustment) with respect to source data 14, and to apply a selection mask to the adjusted data to generate destination data, as described above with reference to blocks 106 and 108 of FIG. 4. For the purposes of discussing the method 230, source image data is designated as 10(r). For color images, I0 will typically consists of several color components or channels, three for RGB or LAB color space, four CMYK, for example. The effect of a marker 163, in the exemplary embodiment, is to produce a new image, namely destination image, I2(r). The method 230 accordingly commences at block 232 with the receipt by the digital image adjustment application 120 of the source image data, I0(r), via the interface component 122, the source image data being received as application data 160 associated with the application 122.

At block 234, a parameterized set of adjustment parameters, q, act on the source image data I0, to produce adjusted image data I1. Specifically, consider that the destination image is produced, in the exemplary embodiment, by application of an image adjustment, as modulated by a selection mask, S(r). The image adjustment, A, parameterized by a set of adjustment parameters, q, acts on the source image data 10 to produce adjusted image data, I1, as follows:
I1(r; q)=A(q)I0(r) (15)

The image adjustment may, in various embodiments, be a linear or a non-linear operation. An example of a linear adjustment is a channel mixer in which each color channel is derived as a linear combination of source color channels. An example of a non-linear operation is a gamma or contrast adjustment, in which each color channel is non-linearly modified by application of a power law; for example in 8-bit RGB color space with I1 equal symbol (red1, green1, blue1),
red1=255* power (red0/255.0, gamma),
green1=255* power (green0/255.0, gamma),
blue1=255* power (blue0/255.0, gamma),
and q=gamma.

Returning to the method 230, at block 236, given the adjusted image, I1(r; q), a blend with the selection mask, S(r) is used to obtain the destination image data I2 according to the following equation:
I2(r; q)=I1(r; q)S(r)+I0(r)(I−S(r)) (16)

In locations where S equal 0, the destination image data is the same as the source image data. In locations where S equals 1, destination image data is the adjusted image data, I1. For intermediate selections strengths, the destination image data is a blend between the source image data and the adjusted image data. For simplicity in representing a formula, it has been assumed that the selection mask is normalized to range in value between 0 and 1.

The resultant image, I2, is parameterized in terms of both the adjustment parameters, q, as well as the selection parameters, qa, and the selection locations, ra, for all of the associated a markers 163 (a equals 1 . . . N).

The above formulation assumes that all of the markers 163 have a common adjustment type and parameter settings. This accordingly justifies the use of a single combined selection mask, S(r). However, as noted above, a collection of markers 163 may be associated with a specific adjustment layer 165. Multiple adjustment layers 165 may be “stacked” on top of each other, each one potentially applying different adjustments. In this scenario, adjustment layer technology, included within a digital image adjustment application 120 may be utilized to blend together the effects of each of the adjustment layers 165.

With respect to FIG. 7, a user interface 190 has been described in which the marker icons 200 have been placed on top of (or overlaid on) an image. Each of a number of markers 163 may have a different associated marker icon 200 depending on the nature of the adjustment, and an adjustment layer 165 in which the relevant marker 163 resides. For example, markers 163 that implement “curves” adjustments may be represented by a special curve-shape marker icon 200, while brightness adjustments may be represented by different marker icons 200. Further, each of the markers 163 that reside in a specific (e.g., a first) adjustment layer 165 may be colored a common color (e.g., red), while those markers 163 that reside in another layer may all be colored a different common color. When a user, utilizing the interface 190, selects a specific adjustment layer 165, the marker icons 200, representing markers 163 associated with the selected adjustment layer 165, may be visible (or otherwise visually distinguished by highlighting, for example), whereas marker icons 200 associated with markers 163 in non-selected adjustment layers 165 may be hidden. Further, when a user selects a specific marker icon 200 on an image representation 192, the associated adjustment layer 165 may be automatically highlighted and selected.

FIG. 11 illustrates a method 240, according to an alternative exemplary embodiment, to adjust a source image data. Whereas the method 230, discussed above, may be performed in the context of an adjustment layer model, the method 240 assumes a so-called “multiple adjustments” model. Specifically, in an alternative embodiment, each of the markers 163 may have an arbitrary associated adjustment type and parameter value. This is conceptually equivalent to an approach in which one marker 163 is allowed per adjustment layer 165 but the composition of each of the adjustment layers 165 is explicitly described. As described above with reference to FIG. 7, the exemplary image interface 190 allows multiple markers 163 to be located with respect to an image representation 192. As also described above with reference to FIG. 7, when a particular marker icon 200 is selected, the associated selection and adjustment parameters may be displayed, for example utilizing the parameter modification display. In one embodiment, these selection and adjustment parameters may simply be displayed in a “pop-up” box adjacent to the selected marker icon 200. Alternatively, the associated selection and adjustment parameters may be displayed within the context of the above-described parameter modification dialog box 210, which allows for the modification of the selection and adjustment parameters. In the “multiple adjustments” model, all of the selection and adjustment parameters may vary from a marker 163 to a marker 163, and there is no requirement regarding uniformity of such parameters. Returning to block 242 of the method 240, one approach to blending pins within the “multiple adjustments” model is to perform a blending of an adjusted image data with a selection mask defined only by “positive polarity” markers 163, to thereby generate second, or intermediate, adjusted image data. Specifically, an approach to blending the markers 163 is provided below:

// Blend the image adjustments for each Magic Pin, as long as its
polarity is positive:
Initialize I(r) to I0(r), the source image, everywhere
For (a = 1; a <= N, ++a)
If (ea = +1)
{
I(r) = A (qa) I(r) S(r; ra, pa) + I(r) (I − S(r, ra, pa)).
}
// Finally, blend the resultant image with the combined selection mask.
I2(r) = I(r) S(r) + I0(r) (1 − S(r)).]

At block 244, the blended second adjusted image data is then blended with a composite selection mask, which incorporates the effect of “negative polarity” markers to thereby block certain image adjustments.

In an alternative embodiment, an approach may be adopted in which the effect of all “positive polarity” markers 163 are first blended with an adjusted image data, and thereafter, resulting second, or “intermediate”, adjusted image data is blended with source image data, utilizing the masks defined by the “negative polarity” markers 163.

// Blend the image adjustments for each Magic Pin, applying negative pins
last.
Initialize I(r) to I0(r), the source image, everywhere
For (a = 1, a <= N, ++a)
If (ea = +1)
{
I(r) = A (qa) I(r) S(r; ra, pa) + I(r) (1 − S(r; ra, pa)).
}
For (a = 1; a <= N; ++a)
If (ea = −1)
{I(r) = I0(r) S(r; ra, pa) + I(r) (1 − S(r; ra, pa)).}
I2(r) = I(r).

As also mentioned above, the selection induced by each marker 163 depends on the associated selection parameters, as well as the image data at the marker location, identified by the location data 18. The image data at the marker location may include image color and pixel location. In addition, it may incorporate image data from the vicinity of the pixel location, such as that from a local neighborhood of pixels or gradient information. The selection associated with a marker 163 may, in one exemplary embodiment, be further refined by allowing a user to identify multiple marker locations to be included in the location data 18, associated with a particular marker 163. In one embodiment, this may be achieved by allowing a user to select a marker icon 200, for example such as that mentioned in FIG. 7, and to enabler the user to “scrub”(e.g., moving in a user-targetted area) the marker icon 200 or a cursor, utilizing a mouse for example, over a region of foreground pixels to provide additional information in the vicinity of an initial marker location. Optionally, the user may be enabled to designate a background region, for example by holding down a modifier key or by checking an appropriate check box within a user interface. Thereafter the user may be enabled to “scrub” the marker icon 200 over the background region.

The net result is that the user has allowed the digital image adjustment application 120 to accumulate a set of foreground points, rf, and a set of background points, rb. These “marker locations” may then be utilized by an appropriate selection mechanism, associated with a marker 163, to provide a more accurate selection mask, which better reflects a user's intent. In one embodiment, a single marker location is registered, but the user provides additional information through scrubbing in the vicinity of the marker location. In another embodiment, scrubbing may be utilized to identify a set of marker locations. In one embodiment, the colors at these multiple marker locations may be utilized, in addition to the pixel locations. Further, a neighborhood of color may be collected from the vicinity of each of these marker locations.

Continuing the example of the user foreground and background marker locations (or “points”), the application 120 may, in one embodiment, consider “color distance” between two points in LAB color space by examining each color axis independently. Along each axis there is a lower bound and an upper bound for the allowed value differences for which the selection masks in non-zero. Utilizing the foreground points, the minimum and maximum values may be calculated for each color axis component, and these values may then be utilized in a color selection algorithm (e.g., of a color selection mechanism color-based selection tool 130). Further, the range of values from the background points may optionally be used to subtract from this range. For example, if the foreground points have a range from LFmin to Lfmax, for the luminescence channel, and the background points have a range from LBmin to LBmax, it is possible to take:

If (LFmin < LBmin < LFmax)
{Lmin = LFmin; Lmax = LBmin;}
else
If (LFmin < LBmax < LFmax)
{Lmin = LBmax; Lmax = LFmax;}
Else
{Lmin = LFmin; Lmax = LFmax}

In this manner, the foreground points determine the base range of the selection criterion, and the background points degrade at this selection range.

In an alternative embodiment, the foreground points are modeled by a Gaussian distribution in color space, and the background points by another Gaussian distribution. The foreground points can be utilized to calculate a foreground color correlation matrix, Mf with components:
Mf ij=<(c−<c>)i(c−<c>)j>f (18)
where <. . . >f indicates an average over all of the foreground points.
Similarly, for the background point,
Mb ij=<(c−<c>)i(c−<c>)j>b (19)
where <. . . >b indicates an average over all of the background points.
Then the selection mask can be defined as:
S(r)=1/(1+k ratio) (20)
where ratio=exp[(c(r)−<c>f)Nf(c(r)−<c>f)−(c(r)−<c>b)Nb(c(r)−<c>b)] and
Nf=½ Mf inverse,
Nb=1 Mb inverse.
   k is a constant that may vary from 0 to 1000. If there are no background points available, we may take Nb=0.

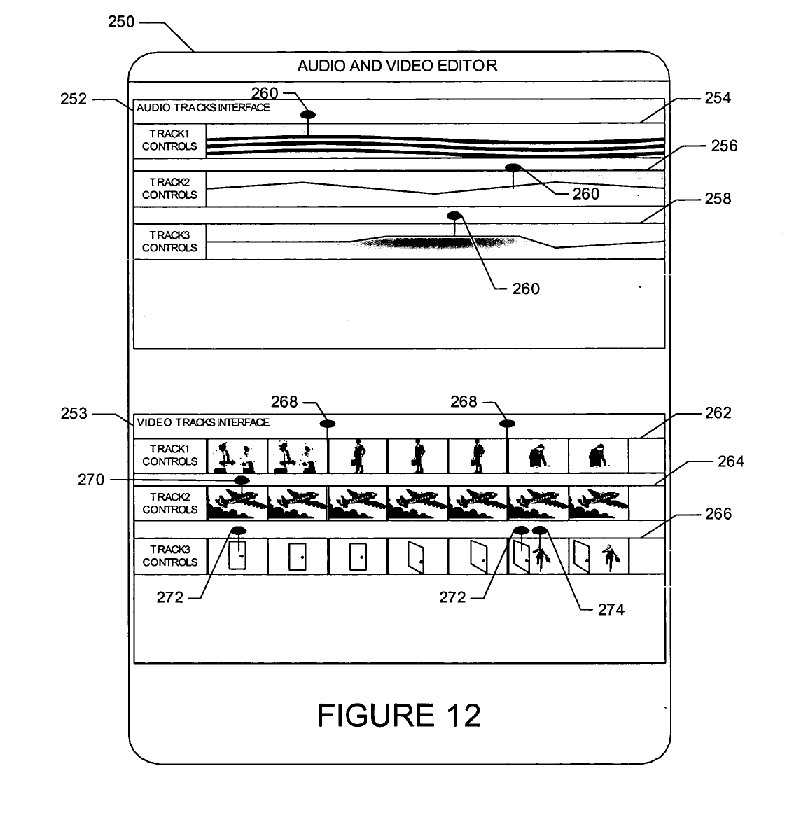

While the discussion of an exemplary embodiment of a digital data activity application 40, provided above with reference to FIGS. 5-11, has focused on an exemplary digital image adjustment application 120, which performs adjustment activities with respect to digital image data, embodiments of the present invention may find application in performing an activity (e.g., tracking, sensing, responding and interacting activities) with respect to other types of digital data. FIG. 12 is a user interface diagram illustrating an exemplary audio and video editor user interface 250, which may be generated by an activity application, in the exemplary form of an audio and video editor application. The interface 250, for example, includes an audio track interface 252 and a video track interface 253. Dealing first with the audio track interface 252, visual representations 254-258 are provided for each of three audio tracks. Marker icons 260 are shown to be located with respect to each of the audio tracks and may, as described above, operate to enable parametrically localized, and parametrically-controlled, activities with respect to each of the represented audio tracks. For example, an underlying marker 16, associated with a particular marker icon 260, may adjust the volume, tone etc. of a particular audio track in a localized manner that may be time-based, or frequency range-based.

Turning to the video track interface 253, representation 262-266 for each of three video tracks are displayed within the video track interface 253, and marker icons, associated with underlying markers 16, are similarly located with respect to the representations 262-266. Again, the markers 16 may perform parametrically localized, and parametrically-controlled, activities with respect to each of the represented video tracks. A discussion of exemplary activities that may be performed with respect to each of the video tracks, by the associated marker 16, has been provided above with reference to FIG. 3.

For example, markers, represented by marker icons 268, that automatically detect scene changes within a video track are shown to be located with respect to a first video track representation 262. A marker, represented by a marker icon 270, that tracks the movement of an image object or feature through a succession of frames, and that applies an image adjustment with respect to the tracked image feature, is shown to be applied to a second video track representation 264. With respect to a third video track representation 266, a marker 16, associated with the marker icon 272, performs a sensing operation with respect to a door feature, and may invoke a responding mechanism when a sensing mechanism detects that the door has been opened. The marker 16, automatically and without user intervention, then instantiates a second marker 16, represented by the marker icon 274, having associated sensing and tracking mechanisms to monitor an image feature representing a person that has entered a building via the open door.

Dealing now in further detail with an exemplary embodiment in which the source data 14 comprises audio data with reference to the audio track interface 252, it will be noted that a marker icon 260 can be located on a representation of an audio track in order simultaneously to select a portion of the relevant audio track and to perform a modification with respect thereto. Specifically, the marker icon 260 may be placed at a specific point in time on the track, and may perform an activity that only affects the relevant track. In an alternative embodiment, a marker icon 260 may be placed on a single track, and may invoke associated mechanisms automatically to select and modify further audio tracks, such as the case where multiple tracks are combined together to produce a single track. In the audio data example, a marker 16 may include as its selection properties time localization, frequency range, and amplitude or frequency pattern, for example.

Time localization may be incorporated by a function of time, which is centered on a time, t0, at which the marker icon 260 is placed, the function decreasing monotonically for times differing from this value. Such an exemplary function is:
s(t)=exp(−(t−t0)²) (21)

Frequency range selection may, in one embodiment, be accomplished by taking a small window in time, centered about a time step, and performing a Fourier transform (e.g., a Discrete Fast Fourier Transform). In this way, the underlying audio data may be decomposed into strengths in a set of frequency bins, for each point in time. A selection process may then select frequency, f, with a strength centered on a selected frequency component f0, which decreases for different components. An example of such a function is:
s(f)=exp(−(f−f0)²) (22)

As noted above, selection may, in a further embodiment, also focus on a pattern of frequencies or audio amplitudes. Where a frequency distribution of a particular prototype sound portion is represented as pf, which specifies a fraction of sound samples that lie within a frequency bin f (e.g., frequencies which lie between frequency f and frequency f+df, where df is the frequency bin width) then a selection function may be defined as follows:
S(f)=Sumₐ{pfa exp(−(f−fₐ)²)} (23)

This weighted summation of individual frequency selections produces a selection for audio signals similar to the prototype patterns.

Adjustment that may, in an exemplary embodiment, be made responsive to association of a marker 16 with a location in audio data may be one of many types. For example, a common adjustment is a filtering operation carried out either in the amplitude signal, or the Fourier transformed frequency signal. One example of such a filtering operation is described in the following publication: IEEE TRANSACTIONS ON SIGNAL PROCESSING, VOL. 45, NO. 6, PP. 1415{1427, JUNE 1997. On Fast FIR Filters Implemented as Tail-Canceling IIR Filters, Avery Wang, Julius O. Smith III

The filtering may amplify and/or suppress various frequency components. Alternatively, the filtering may stretch or synchronize the audio signal in time. The filtering may also, in another embodiment, change the “voicing” or timbre of the sound. Alternatively, an activity may be a substitution activity, where the marker 16 substitutes one portion of sounds for another.

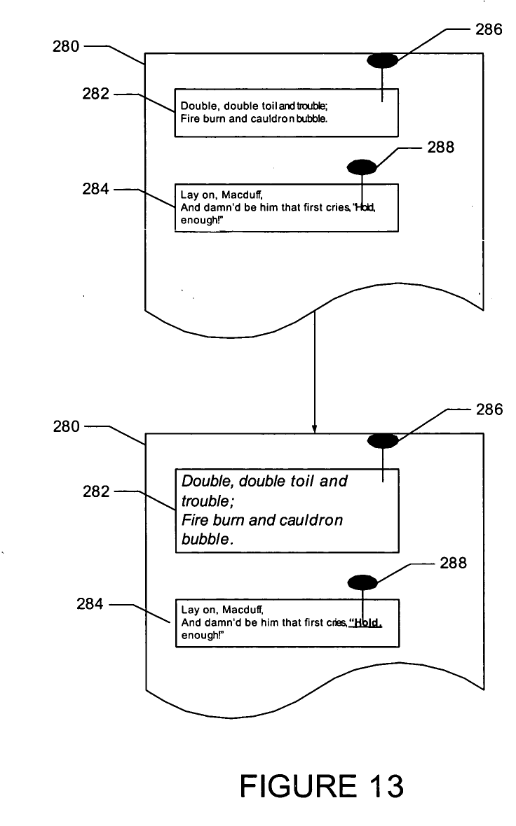

In yet a further exemplary embodiment of the present invention, the digital image adjustment application 120 may be a document editing application (e.g., MS WORD developed by Microsoft Corporation of Redmond, Washington State). To this end, FIG. 13 illustrates exemplary source data 14 in the form of a text document 280, which includes two text portions 282 and 284. Marker icons 286 and 288, each associated with a respective underlying marker 16, are shown to have been located with respect to the text portions 282 and 284. The marker 16 associated with the marker icon 286, in the exemplary embodiment, includes a selection mechanism, and appropriate selection parameters, to configure the marker to perform a paragraph selection.

The user need not locate a marker icon 286 directly on a specific text element (e.g., word, sentence or paragraph) for the selection of that text element. Indeed, the selection mechanism, associated a marker underlying a marker icon 286, may operate to detect a text element in the vicinity of a marker location. The selected text element is then automatically highlighted, or otherwise visually differentiated, to indicate the text element selection that has been performed. This visual differentiation provides feedback to the user regarding the text element that has been selected. The selection mechanism may be configured to select any one of a number of text elements types (e.g., words, sentences or paragraphs), and the marker accordingly provides a quick and efficient mechanism for the selection of a text element with respect to which an activity may be performed.

Further, an activity mechanism, and associated control parameters, causes a text editing application to increase the font size of the selected paragraph to a predetermined size.

Similarly, a marker 16 underlying the marker icon 288 is configured, by an appropriate selection mechanism and control parameter, to select a single word at, or adjacent, to the marker icon 288, and to perform a format conversion with respect to that word (e.g., to convert the word to a hypertext link identifying a predetermined (or dynamically determined) resource location). In this example, the word “hold” is shown to be reformatted as a hypertext link and, for example, to be associated with a URL that points to a dictionary application residing on the Internet.

Considering other document types, rendered web pages may change content from day to day. Taking the New York Times website as an example, assuming the user is interested in determining whenever there is a new travel article published on the website. In this case, the user may be presented, for example by a browser application, with a marker icon, representing an underlying tracking marker 16, which allows user location on a specific word (e.g., “travel”) appearing at a specific location on a website served up from the New York Times website. The exemplary marker 16 is designated, utilizing an appropriate sensing mechanism and tracking mechanism, to track this word (e.g., to search for this word in the vicinity of the marker location to allow for variations in its placement). The marker 16 is also designated, by an appropriate responding mechanism and associated control parameter, to respond whenever the text beneath the relevant word changes. Accordingly, the marker 16 may be regarded as an intelligent agent that is dependent on rendered text. For example, in this example, the marker 16 would ignore the word “travel” which might occur in other parts of the rendered web page.

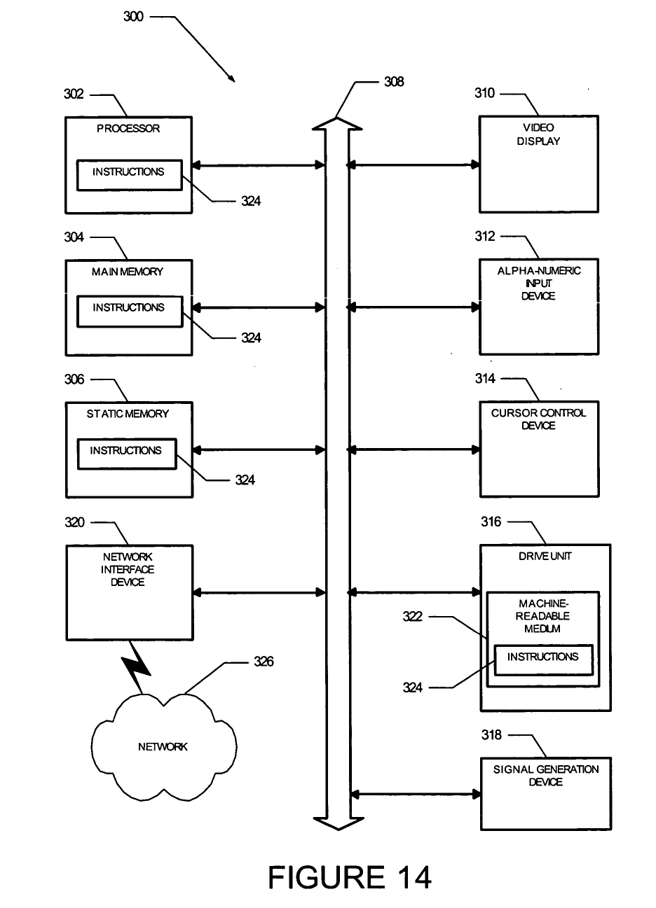

FIG. 14 shows a diagrammatic representation of machine in the exemplary form of a computer system 300 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, an embedded system or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and a system to perform localized activities with respect to digital data have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than restrictive sense.

What is claimed is:

1. A system to perform localized activity with respect to digital data, the system including:
an interface component to receive a marker location with respect to source digital data; and
an activity component automatically to perform a parametrically-controlled activity with respect to the source digital data, based on an activity parameter,
wherein the activity component is to perform a parametrically-controlled selection of a selected portion of the source digital data, based on the marker location and a portion selection parameter, and to localize an effect of the parametrically-controlled activity to the selected portion of the source digital data.

2. The system of claim 1, wherein activity component is automatically to perform the parametrically-controlled selection and parametrically-controlled activity responsive to the receipt of the marker location by the interface component.

3. The system of claim 1, wherein the interface component, subsequent to the performance of the parametrically-controlled activity, is to enable a user to modify at least one of the activity parameter and the portion selection parameter, while the marker location is maintained, to modify the localized effect of the parametrically-controlled activity.

4. The system of claim 3, wherein the maintenance of the marker location includes maintaining display of a graphical marker icon at the marker location subsequent to the performance of the parametrically-controlled activity.

5. The system of claim 1, wherein the source digital data is source image data, and the parametrically-controlled activity includes a parametrically-controlled adjustment activity to adjust a visual representation of the source image data.

6. The system of claim 5, wherein the parametrically-controlled activity includes a sensing activity to identify an image feature characteristic within the source image data, and the activity component is to initiate the parametrically-controlled adjustment activity based on the identified image feature characteristic.

7. The system of claim 1, wherein the source image data is source video data, and the parametrically-controlled activity includes a parametrically-controlled tracking activity to track an image feature within the source video data.

8. The system of claim 7, wherein the source video data includes at least first and second frames, and the parametrically-controlled activity includes a sensing activity to sense a change with respect to the image feature, within the source video data, between the first and the second frames, and a response activity to perform a response operation based on the sensed change.

9. The system of claim 8, wherein the response activity is a parametrically-controlled adjustment activity with respect to the image feature.

10. The system of claim 8, wherein the response activity includes generating a notification of the sensed change.

11. The system of claim 8, wherein the response activity includes creating a further marker location with respect to a further image feature.

12. The system of claim 1, wherein the source digital data is source audio data, and the parametrically-controlled activity is to adjust an audio representation of the source audio data.

13. The system of claim 11, wherein the portion selection parameter is at least one parameter of a group of parameters including a time range parameter, a frequency range parameter, an amplitude pattern parameter and a frequency pattern parameter.

14. The system of claim 1, wherein the source digital data is source document data, and the parametrically-controlled activity is to adjust a visual representation of the source document data.

15. The system of claim 1, wherein the activity component is to perform the parametrically-controlled adjustment, utilizing the source digital data, to generate adjusted digital data, and is to localize effects of the parametrically-controlled adjustment activity, with respect to the adjusted digital data, to generate a destination digital data.

16. The system of claim 1, wherein the activity component is to perform the parametrically-controlled activity with respect to the source digital data, and subsequently to localize the effects of the parametrically-controlled activity to the selected portion of the source digital data.

17. The system of claim 1, wherein the activity component is to perform the parametrically-controlled selection of the selected portion, and subsequently to localize the effects of the parametrically-controlled activity with respect to the selected portion of the source digital data.

18. The system of claim 1, wherein the interface component is to provide a visual representation of a marker at the marker location with respect to the source digital data.

19. The system of claim 18, wherein the interface component is to enable user-controlled location of the visual representation of the marker with respect to the source digital data.

20. The system of claim 18, wherein the interface component is to enable user-controlled relocation of the visual representation of the marker with respect to the source digital data, thereby to identify a further marker location with respect to the source digital data on which a further parametrically-controlled selection of a further selected portion is based.

21. The system of claim 1, wherein the interface component is to enable modification of the portion selection parameter, while the activity parameter is maintained, to facilitate a parametrically-controlled selection of a further selected portion of the source digital data.

22. The system of claim 1 wherein the interface component is to enable modification of the activity parameter, while the selection of the selected portion of the source digital data is maintained, thereby to facilitate a further parametrically-controlled activity with respect to the source digital data.

23. The system of claim 1, wherein the interface component is to receive a plurality of marker locations.

24. The system of claim 23, wherein the activity component is to perform a plurality of parametrically-controlled selections and activities with respect to the source digital data, based on the plurality of marker locations.

25. The system of claim 23, wherein the activity component is to perform a single parametrically-controlled selection and activity with respect to the source digital data, based on the plurality of marker locations.

26. The system of claim 23, wherein the activity component is to define a selection mask with respect to the source digital data, based on each of the plurality of marker locations and associated respective portion selection parameters.

27. The system of claim 23, wherein a first marker location of the plurality of marker locations has a polarity parameter associated therewith, the polarity parameter to be utilized by the activity component to determine whether the localized effects of the parametrically-controlled activity are to be at least one of negatively, neutrally and positively applied with respect to at least a portion of the selection mask defined based on the first marker location.

28. The system of claim 1, wherein the activity component is to perform a non-destructive activity with respect to the digital source data based on the activity parameter.

29. The system of claim 28, wherein the activity component is to enable creation of an activity layer, which is distinct from the digital source data, which modifies a representation of the digital source data, and is to perform the parametrically-controlled selection and activity with respect to the adjustment layer, thereby to perform the non-destructive activity.

30. The system of claim 29, wherein the activity component is to enable creation of a plurality of activity layers, and is to perform respective parametrically-controlled selections and activities with respect to each of the plurality of activity layers.

31. The system of claim 29, wherein the activity component is to enable selective activation and deactivation of each of the plurality of activity layers to thereby modify a representation of the digital source data.

32. The system of claim 1, wherein the portion selection mechanism is one of a plurality of portion selection mechanisms available to the system, and the interface component is further to receive a selection of the portion selection mechanism.

33. The system of claim 32, wherein each of the plurality of the portion selection mechanisms is a digital image region selection mechanism selected from a group including at least one of a geometric selection mechanism, a color-based selection mechanism, and an edge-based selection mechanism.

34. The system of claim 1, wherein the activity component includes an activity mechanism to receive the activity parameter, and is to perform the activity utilizing the activity parameter.

35. The system of claim 34, wherein the activity mechanism is one of a plurality of activity mechanisms, the interface component further to receive a selection of the activity mechanism from among the plurality of activity mechanisms.

36. The system of claim 35, wherein each of the plurality of activity mechanisms is a digital image adjustment mechanism selected from a group including at least one of a color, brightness, shadow, highlight, and filter adjustment mechanisms.

37. The system of claim 34, wherein the interface component is to present a predetermined activity mechanism for user-selection and application to the digital source data, the predetermined activity mechanism employing a default activity value for the activity parameter.

38. The system of claim 37, wherein the predetermined activity mechanism is associated with a predetermined portion selection mechanism, the predetermined portion selection mechanism employing a default value for the portion selection parameter.

39. The system of claim 1, wherein the interface component is to receive at least one marker location and additional input identifying locations in a vicinity of the at least one marker location.

40. The system of claim 39, wherein the activity component is to perform a single parametrically-controlled selection and activity with respect to the source digital data, based on the at least one marker location and the additional input.

41. The system of claim 39, wherein the activity component is to define a selection mask with respect to the source digital data, based on the at least one marker location and the additional input.

42. A method to perform localized activity with respect to digital data, the method including:
receiving a marker location with respect to source digital data;
automatically performing a parametrically-controlled activity with respect to the source digital data, based on an activity parameter; and
automatically performing a parametrically-controlled selection of a selected portion of the source digital data, based on the marker location and a portion selection parameter; and
automatically localizing an effect of the parametrically-controlled activity to the selected portion of the source digital data.

43. The method of claim 42, including automatically performing the parametrically-controlled selection and parametrically-controlled activity responsive to the receipt of the marker location.

44. The method of claim 42, including, subsequent to the performance of the parametrically-controlled activity, enabling user modification of at least one of the activity parameter and the portion selection parameter, while the marker location is maintained, and automatically modifying the localized effect of the parametrically-controlled activity based on the user modification.

45. The method of claim 44, wherein the maintenance of the marker location includes maintaining display of a graphical marker icon at the marker location subsequent to the performance of the parametrically-controlled activity.

46. The method of claim 42, wherein the source digital data is source image data, and the parametrically-controlled activity includes a parametrically-controlled adjustment activity to adjust a visual representation of the source image data.

47. The method of claim 46, wherein the parametrically-controlled activity includes a sensing activity to identify an image feature within the source image data, and the method includes initiating the parametrically-controlled adjustment activity based on the identified image feature.

48. The method of claim 42, wherein the source image data is source video data, and the parametrically-controlled activity includes a parametrically-controlled tracking activity to track an image feature within the source video data.

49. The method of claim 48, wherein the source video data includes at least first and second frames, and the parametrically-controlled activity includes a sensing activity to sense a change with respect to the image feature, within the source video data, between the first and the second frames, and a response activity to perform a response operation based on the sensed change.

50. The method of claim 49, wherein the response activity a parametrically-controlled adjustment activity with respect to the image feature.

51. The method of claim 49, wherein the response activity includes generating a notification of the sensed change.

52. The method of claim 49, wherein the response activity includes automatically instantiating a further marker location with respect to a further image feature.

53. The method of claim 42, wherein the source digital data is source audio data, and the parametrically-controlled activity is to adjust an audio representation of the source audio data.

54. The method of claim 44, wherein the portion selection parameter is at least one of a group including a time range parameter, a frequency range parameter, an amplitude pattern parameter and a frequency pattern parameter.

55. The method of claim 42, wherein the source digital data is source document data, and the parametrically-controlled activity is to adjust a visual representation of the source document data.

56. The method of claim 42, including performing the parametrically-controlled adjustment, utilizing the source digital data, to generate adjusted digital data, and localizing effects of the parametrically-controlled adjustment activity, with respect to the adjusted digital data, to generate a destination digital data.

57. The method of claim 42, including performing the parametrically-controlled activity with respect to the source digital data, and subsequently localizing the effects of the parametrically-controlled activity to the selected portion of the source digital data.

58. The method of claim 42, including performing the parametrically-controlled selection of the selected portion, and subsequently localizing the effects of the parametrically-controlled activity with respect to the selected portion of the source digital data.

59. The method of claim 42, including providing a visual representation of a marker at the marker location with respect to the source digital data.

60. The method of claim 59, wherein receipt of the marker location includes detecting user-controlled location of the visual representation of the marker with respect to the source digital data.

61. The method of claim 60, including detecting user-controlled relocation of the visual representation of the marker with respect to the source digital data, thereby to identify a further marker location with respect to the source digital data on which a further parametrically-controlled selection of a further selected portion is based.

62. The method of claim 42, including detecting modification of the portion selection parameter, while the activity parameter is maintained, and performing a parametrically-controlled selection of a further selected portion of the source digital data responsive to the detection of the modification of the portion selection parameter.

63. The method of claim 42, including detecting modification of the activity parameter, while the selection of the selected portion of the source digital data is maintained, and performing a further parametrically-controlled activity with respect to the source digital data responsive to the detection of the modification of the activity parameter.

64. The method of claim 42, including receiving a plurality of marker locations.

65. The method of claim 64, including performing a plurality of parametrically-controlled selections and activities with respect to the source digital data, based on the plurality of marker locations.

66. The method of claim 64, including performing a single parametrically-controlled selection and activity with respect to the source digital data, based on the plurality of marker locations.

67. The method of claim 64, including defining a selection mask with respect to the source digital data, based on each of the plurality of marker locations and associated respective portion selection parameters.

68. The method of claim 64, wherein a first marker location of the plurality of marker locations has a polarity parameter associated therewith, the method including utilizing the polarity parameter to determine whether the localized effects of the parametrically-controlled activity are to be negatively or positively applied with respect to at least a portion of the selection mask defined based on the first marker location.

69. The method of claim 42, including performing a non-destructive activity with respect to the digital source data based on the activity parameter.

70. The method of claim 69, including detecting creation of an activity layer, which is distinct from the digital source data, that modifies a representation of the digital source data, and automatically performing the parametrically-controlled selection and activity with respect to the adjustment layer, thereby to perform the non-destructive activity.

71. The method of claim 70, including detecting creation of a plurality of activity layers, and automatically performing respective parametrically-controlled selections and activities with respect to each of the plurality of activity layers.

72. The method of claim 67, including detecting activation and deactivation of each of the plurality of activity layers to thereby modify a representation of the digital source data.

73. The method of claim 42, wherein the portion selection mechanism is one of a plurality of portion selection mechanisms, the method including receiving a selection of the portion selection mechanism from among the plurality of portion selection mechanisms.

74. The method of claim 73, wherein each of the plurality of the portion selection mechanisms is a digital image region selection mechanism selected from a group including at least one of a geometric selection mechanism, a color-based selection mechanism, and an edge-based selection mechanism.

75. The method of claim 42, including receiving the activity parameter, associating the activity parameter with an activity mechanism, and automatically performing the activity utilizing the activity mechanism in conjunction with the activity parameter.

76. The method of claim 75, wherein the activity mechanism is one of a plurality of activity mechanisms, the method including receiving selection of the activity mechanism from among the plurality of activity mechanisms.

77. The method of claim 76, wherein each of the plurality of activity mechanisms is a digital image adjustment mechanism selected from a group including at least one of a color, brightness, shadow, highlight, and filter adjustment mechanisms.

78. The method of claim 75, including presenting a predetermined activity mechanism for user-selection and application to the digital source data, the predetermined activity mechanism employing a default activity value for the activity parameter.

79. The method of claim 78, wherein the predetermined activity mechanism is associated with a predetermined portion selection mechanism, the predetermined portion selection mechanism employing a default value for the portion selection parameter.

80. The method of claim 42, including receiving at least one marker location and additional input identifying locations in a vicinity of the at least one marker location.

81. The method of claim 80, including performing a single parametrically-controlled selection and activity with respect to the source digital data, based on the at least one marker location and the additional input.

82. The method of claim 80, including defining a selection mask with respect to the source digital data, based on the at least one marker location and the additional input.

83. A data structure including:
marker location data to identify a location with respect to digital data;
activity control data identifying an activity, and including at least one activity parameter to control the activity, the activity to be performed in a parametrically-controlled manner with respect to the digital data; and
selection control data identifying a selection method, and including at least one selection parameter to control the selection method, the selection method to be performed in a parametrically-controlled manner with respect to the digital data to localize the activity with respect to a selected portion of the digital data.

84. The data structure of claim 83, wherein the selection control data is to be utilized to define a selection mask according to which the activity is localized with respect to the selected portion of the digital data.

85. The data structure of claim 83, wherein the activity control data is to identify at least one of a group of the activities, the group of activities including a data adjustment activity, a data tracking activity, a data sensing activity, a data responding activity and a data interaction activity.

86. The data structure of claim 83, wherein the selection control activity is to identify at least one of a group of selection methods, the group of selection methods including a geometric selection method, a color-based selection method, and an edge-based selection method.

87. The data structure of claim 83, wherein the marker location data identifies a plurality of locations with respect to the digital data, the activity control data identifies a plurality of activities to be applied respectively utilizing the plurality of locations, and the selection control data identifies a plurality of selection methods to be applied respectively utilizing the plurality of locations.

88. A method to define data structure, the method including:
receiving, from a user, marker location data to identify a location with respect to digital data;
creating activity control data identifying an activity, and including at least one activity parameter to control the activity, the activity to be performed in a parametrically-controlled manner with respect to the digital data; and
creating selection control data identifying a selection method, and including at least one selection parameter to control the selection method, the selection method to be performed in a parametrically-controlled manner with respect to the digital data to localize the activity with respect to a selected portion of the digital data.

89. The method of claim 88, wherein the selection control data is to be utilized to define a selection mask according to which the activity is localized with respect to the selected portion of the digital data.

90. The method of claim 88, wherein the activity control data is to identify at least one of a group of the activities, the group of activities including a data adjustment activity, a data tracking activity, a data sensing activity, a data responding activity and a data interaction activity.

91. The method of claim 88, wherein the selection control activity is to identify at least one of a group of selection methods, the group of selection methods including a geometric selection method, a color-based selection method, and an edge-based selection method.

92. The method of claim 88, wherein the marker location data identifies a plurality of locations with respect to the digital data, the activity control data identifies a plurality of activities to be applied respectively utilizing the plurality of locations, and the selection control data identifies a plurality of selection methods to be applied respectively utilizing the plurality of locations.

93. A system to perform adjustments to a digital image, the system including:
a data structure including marker location data to identify a location with respect to digital image, activity control data identifying a parametrically-controlled image adjustment activity, and including at least one activity parameter to control the parametrically-controlled image adjustment activity, and selection control data identifying a selection method, and including at least one selection parameter to control the selection method;
an interface component to allow a user to locate a marker icon with respect to a source digital image, and to receive the marker location data with respect to the source digital image responsive to the user-location of the marker icon; and
an image adjustment component automatically to perform the parametrically-controlled image adjustment activity with respect to the source digital image, based on the at least one activity parameter,
wherein the image adjustment component is to perform a parametrically-controlled selection of a selected portion of the source digital image using the selection method, based on the marker location and the at least one portion selection parameter, and is to localize an effect of the parametrically-controlled activity to the selected portion of the source digital image.

94. A machine-readable medium storing a set of instructions that, when executed by a machine, cause the machine to perform a method to perform localized activity with respect to digital data, the method including:
receiving a marker location with respect to source digital data;
automatically performing a parametrically-controlled activity with respect to the source digital data, based on an activity parameter; and
automatically performing a parametrically-controlled selection of a selected portion of the source digital data, based on the marker location and a portion selection parameter; and
automatically localizing an effect of the parametrically-controlled activity to the selected portion of the source digital data.

95. A system to perform localized activity with respect to digital data, the system including:
first means for receiving a marker location with respect to source digital data; and
second means for automatically performing a parametrically-controlled activity with respect to the source digital data, based on an activity parameter,
wherein the second means is for performing a parametrically-controlled selection of a selected portion of the source digital data, based on the marker location and a portion selection parameter, and for localizing an effect of the parametrically-controlled activity to the selected portion of the source digital data.
